(19) United States
(12) Patent Application Publication
(10) Pub. No.: US 2020/0265450 A1
(43) Pub. Date: Aug. 20, 2020

(54) Composite Radial-Angular Clustering Of A Large-Scale Social Graph

(71) Applicant: AFFINIO INC., Halifax (CA)

(72) Inventor: Stephen James Frederic HANKINSON, Hammonds Plains (CA)

(21) Appl. No.: 16/647,423

(22) PCT Filed: Sep. 13, 2018
(86) PCT No.: PCT/IB2018/057019

§ 371 Date: Mar. 13, 2020

Related U.S. Application Data
(60) Provisional application No. 62/558,085, filed on Sep. 13, 2017.

(51) Int. Cl. G06Q 30/02; G06K 9/62; G06F 16/906; G06Q 50/00

(52) U.S. Cl. CPC G06Q 30/0204; G06Q 50/01; G06F 16/906; G06K 9/6223

(57) ABSTRACT

A method of segmenting a large number of objects representing tracked-users of a network into a number of clusters is disclosed. Each object is represented by a multi-dimensional vector representing descriptors of the object. An object is assigned to a particular cluster according to the radial distance to, and the angular displacement from, a centroid vector of the particular cluster.

### CROSS-REFERENCE TO RELATED APPLICATIONS

The present application is a national entry of PCT/IB2018/057019 filed Sep. 13, 2018, which claims the benefit of provisional application 62/558,085 filed on Sep. 13, 2017, entitled “Composite Radial-Angular Clustering of a Large Scale Social Graph”, the entire content of both applications being incorporated herein by reference.

### FIELD OF THE INVENTION

The present invention relates to clustering of a large number of objects. In particular, the invention is directed to segmentation of a social graph representing a large number of tracked users of social networks.

### BACKGROUND OF THE INVENTION

Informed marketing models rely on analyzing massive data, pertinent to identifiable objects, acquired from a variety of sources, one of which being the social media. The data fed to a market model may be segmented according to various criteria where objects of cohesive or similar characteristics are grouped in identifiable clusters. Several methods of data clustering are known in the art. There are however several challenges pertaining to computational complexity, selection of appropriate descriptors of objects, and selection of segmentation criteria that suit marketing objective.

### SUMMARY OF THE INVENTION

The invention provides a method of clustering a plurality of objects representing tracked users of a network. The method is implemented using at least one processor configured to perform processes of initializing K centroids, one for each of a specified number K of clusters, K>1, and assigning each object to one of the clusters according to measures of affinity of the object to each of the centroids.

The process of assigning an object to a cluster is based on determining with respect to each of the K centroids: an angular-affinity measure; a radial distance; a radial-affinity measure based on the radial distance; and a composite affinity measure based on the radial-affinity measure and the angular-affinity measure. The object is assigned to a selected cluster having a centroid of least composite affinity measure.

The centroid of the selected cluster is updated to account for inclusion of the object.

According to one aspect of the invention, there is provided a method of clustering a plurality of objects comprising:
configuring at least one hardware processor to perform processes of:
generating a set of K centroids, K>1;
assigning each centroid to a respective cluster of a set of K clusters;
selecting objects of said plurality of objects in a predetermined order and for each object of said plurality of objects:
   evaluating a composite affinity measure to each centroid of the K centroids based on a radial-affinity measure and an angular-affinity measure to said each centroid;
   identifying a particular centroid of highest composite affinity measure;
   assigning said each object to a particular cluster corresponding to the particular centroid; and
   updating said particular centroid to a respective updated centroid to account for inclusion of said each object;
and
storing identifiers of objects assigned to said each cluster.

In the method described above, said each object is characterized by a respective vector of descriptors and said updating comprises steps of:
maintaining a count of current objects assigned to said particular cluster;
maintaining a vector sum of vectors of descriptors of said current objects; and
determining said respective updated centroid as said vector sum divided by said count.

The method further comprises:
assigning to said each object a respective weight; and
establishing said predetermined order as a descending order according to weight.

The method further comprises executing multiple cycles of said selecting, evaluating, identifying, assigning, and updating for said each object with the predetermined order for any cycle differing from the predetermined order for any other cycle of the multiple cycles.

The method further comprises, for each cycle of said multiple cycles:
generating a respective pseudo-random sequence of different integers corresponding to memory addresses of vectors of descriptors of said plurality of objects; and
establishing said predetermined order according to said respective pseudo-random sequence.

The method further comprises:
maintaining object-assignment records indicating for each object:
   an identifier of a cluster to which said each object is assigned; and
   a corresponding composite affinity measure;
executing a specified number of cycles of said selecting, evaluating, identifying, assigning, and updating for said each object of said plurality of objects; and
executing each of a specified number of succeeding cycles of said selecting, evaluating, identifying, assigning, and updating for only each object of a composite affinity measure below a specified level.

The method further comprises:
determining an overall number of changes of object assignments to clusters for a cycle of said selecting, said evaluating, identifying, assigning, and updating for said each object; and
while a ratio of said overall number to a total number of objects of said plurality of objects exceeds a predefined threshold repeating said cycle at most a predefined number of times.

The method further comprises determining each of said radial-affinity measure, said angular-affinity measure, and said composite affinity measure as a normalized value bounded between 0 and 1.0.

In the method described above:

said angular affinity measure is determined as a dot product of vectors (C/∥C∥) and (P/∥P∥);
said radial affinity measure is determined as a ratio ∥P∥/(∥P∥+D); and
said composite affinity measure is a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥.

Alternatively, in the method described above:

said angular affinity measure is determined as a dot product of vectors (C/∥C∥) and (P/∥P∥);
said radial affinity measure is determined as (1−D/D*) for D<D* and 0.0 otherwise;
and
   said composite affinity measure is a weighted sum of said angular affinity measure and said radial affinity measure;
   where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥, and D* is a predefined distance threshold, D*>0.

According to another aspect of the invention, there is provided a system of clustering a plurality of objects comprising:
at least one hardware processor and at least one memory device storing processor readable instructions causing the at least one hardware processor to:
generate a set of K centroids, K>1;
assign each centroid to a respective cluster of a set of K clusters;
select objects of said plurality of objects in a predetermined order and for each object of said plurality of objects:
   evaluate a composite affinity measure to each centroid of the K centroids based on a radial-affinity measure and an angular-affinity measure to said each centroid;
   identify a particular centroid of highest composite affinity measure;
   assign said each object to a particular cluster corresponding to the particular centroid; and
   update said particular centroid to a respective updated centroid to account for inclusion of said each object;
and
store identifiers of objects assigned to said each cluster.

The system further comprises means for characterizing said each object by a respective vector of descriptors, said processor readable instructions further cause said at least one processor to:
maintain a count of current objects assigned to said particular cluster;
maintain a vector sum of vectors of descriptors of said current objects; and
determine said respective updated centroid as said vector sum divided by said count.

The system further comprises means for assigning to said each object a respective weight, said processor readable instructions further causing said at least one processor to establish said predetermined order as a descending order according to weight.

In the system described above, said processor readable instructions further cause said at least one hardware processor to execute multiple cycles of assigning said plurality of objects to said set of clusters with the predetermined order of selecting objects for any cycle differing from the predetermined order for any other cycle of the multiple cycles.

In the system described above, said processor readable instructions further cause said at least one processor to:
generate, for each cycle of said multiple cycles, a respective pseudo-random sequence of different integers corresponding to memory addresses of vectors of descriptors of said plurality of objects; and
establish said predetermined order according to said respective pseudo-random sequence.

In the system described above, said processor readable instructions further cause said at least one processor to:
maintain object-assignment records indicating for each object:
   an identifier of a cluster to which said each object is assigned; and
   a corresponding composite affinity measure;
execute a specified number of cycles of assigning objects to clusters for said each object of said plurality of objects; and
execute each of a specified number of succeeding cycles of assigning objects to clusters for only each object of a composite affinity measure below a specified level.

In the system described above, said processor readable instructions further cause said at least one processor to:
determine an overall number of changes of object assignments to clusters for a cycle of assigning objects to clusters for said each object; and
repeat said cycle at most a predefined number of times while a ratio of said overall number to a total number of objects of said plurality of objects exceeds a predefined threshold.

The system further comprises computer executable instructions causing the at least one hardware processor to determine each of said radial-affinity measure, said angular-affinity measure, and said composite affinity measure as a normalized value bounded between 0 and 1.0.

In the system described above, said processor readable instructions further cause said at least one hardware processor to:
determine said angular affinity measure as a dot product of vectors (C/∥C∥) and (P/∥P∥);
determine said radial affinity measure as a ratio ∥P∥/(∥P∥+D); and
determine said composite affinity measure as a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥.

Alternatively, in the system described above, said processor readable instructions further cause said at least one processor to:
determine said angular affinity measure as a dot product of vectors (C/∥C∥) and (P/∥P∥);
determine said radial affinity measure as (1−D/D*) for D<D* and zero otherwise; and
determine said composite affinity measure as a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥, and D* is a predefined distance threshold, D*>0.

According to yet another aspect of the invention, there is provided a method of clustering a plurality of objects comprising:

storing descriptor vectors of N objects of said plurality of objects in a memory device; and configuring at least one hardware processor to perform processes of:
generating a plurality of distinct sets of K centroid seeds, 3<2K<N; and
generating a plurality of distinct pseudo-random sequences of N non-repeating integers corresponding to memory addresses of said memory device of descriptor vectors;
executing M independent segmentation processes of said N objects based on composite radial-angular affinity, M>2, each segmentation starting with a respective one of said sets of K centroid seeds selecting objects for allocation to clusters according to a respective pseudo-random sequence, said each segmentation producing a respective set of K centroids;
segmenting a plurality of centroids resulting from said executing into K constellations starting with any of said sets of K centroids as K constellation seeds and assigning each of remaining centroids to one of K constellations; and
allocating each object selected according to said respective pseudo-random sequence to a respective constellation according to constituent centroids of the K constellations.

In the method described above, said each segmentation comprises:
assigning each centroid seed to a respective cluster of a set of K clusters;
for said each object:
   evaluating a composite affinity measure to each centroid of the K centroids based on a radial-affinity measure and an angular-affinity measure to said each centroid; identifying a particular centroid of highest composite affinity measure;
   assigning said each selected object to a particular cluster corresponding to the particular centroid; and
   updating said particular centroid to a respective updated centroid to account for inclusion of said each selected object.

In the method described above, said allocating comprises:
determining a center of each constellation of said K constellations based on said constituent centroids;
determining an affinity measure of said each object to said center; and
selecting a constellation to the center of which said each object has highest affinity measure.

In the method described above, said allocating comprises:
identifying a specific centroid of said plurality of centroids to which said each object has highest composite affinity measure; and
selecting a constellation containing said specific centroid.

The method further comprises maintaining object-assignment records indicating for said each selected object:
an identifier of a cluster to which said each selected object is assigned; and
a corresponding composite affinity measure.

In the method described above, said M independent segmentations are executed sequentially. Alternatively, said M independent segmentations may be executed concurrently.

According to further aspect of the invention, there is provided a system for clustering a plurality of objects comprising:
at least one hardware processor and a memory device having computer executable instructions stored thereon for execution by the hardware processor, causing the hardware processor to: obtain and store descriptor vectors of N objects of said plurality of objects in the memory device; and
generate a plurality of distinct sets of K centroid seeds, 3<2K<N;
generate a plurality of distinct pseudo-random sequences of N non-repeating integers corresponding to memory addresses of said memory device of descriptor vectors;
execute M independent segmentation processes of said N objects based on composite radial-angular affinity, M>2, each segmentation starting with a respective one of the sets of K centroid seeds and selecting objects for allocation to clusters according to a respective pseudo-random sequence, said each segmentation producing a respective set of K centroids;
segment a plurality of centroids resulting from the segmentation processes into K constellations starting with any of said sets of K centroids as K constellation seeds and assigning each of remaining centroids to one of K constellations; and
   allocate each object selected according to said respective pseudo-random sequence to a respective constellation according to constituent centroids of the K constellations.

In the system described above, the computer executable instructions cause said at least one hardware processor to:
assign each centroid seed to a respective cluster of a set of K clusters;
for said each object:
   evaluate a composite affinity measure to each centroid of the K centroids based on a radial-affinity measure and an angular-affinity measure to said each centroid; identify a particular centroid of highest composite affinity measure;
   assign said each selected object to a particular cluster corresponding to the particular centroid; and
   update said particular centroid to a respective updated centroid to account for inclusion of said each selected object.

In the system described above, the computer executable instructions cause said at least one hardware processor to:
determine a center of each constellation of said K constellations based on said constituent centroids;
determine an affinity measure of said each object to said center; and select a constellation to the center of which said each object has highest affinity measure.

In the system described above, the computer executable instructions cause said at least one hardware processor to:
identify a specific centroid of said plurality of centroids to which said each object has highest composite affinity measure; and
select a constellation containing said specific centroid.

In the system described above, the computer executable instructions further cause said at least one hardware processor to maintain object-assignment records indicating for said each selected object:
an identifier of a cluster to which said each selected object is assigned; and
a corresponding composite affinity measure.

In the system described above, the computer executable instructions further cause said at least one hardware processor to execute said M independent segmentations sequentially.

Alternatively, the system comprises means for executing said M independent segmentations concurrently.

According to one more aspect of the invention, there is provided a method of clustering a plurality of objects comprising:

employing at least one hardware processor for:
obtaining for every object of the plurality of objects a respective characterizing object vector;
initializing a singular affinity of said every object to exceed 1.0;
initializing a set of clusters of objects as empty sets;
assigning a centroid with a respective centroid vector to each cluster of the set of clusters;
during each phase of successive phases, determining a phase-specific affinity threshold and actuating a predefined number of cycles performing for each cycle processes of:
   determining an affinity level of each object having a respective singular affinity below said phase-specific affinity threshold to said each cluster according to said respective characterizing object vector and said respective centroid vector; and assigning said each object to a specific cluster corresponding to highest affinity level.

The method further comprises, upon completion of said each cycle:
revising said respective singular affinity to equal said highest affinity level; and
updating a centroid vector of said each cluster.

The method further comprises:
preceding said each phase, determining for said each cluster a respective phase-specific vector sum of object vectors of all objects assigned to said each cluster each having a respective singular affinity not less than said phase-specific affinity threshold; and
during said each cycle, determining for said each cluster a respective cycle-specific vector sum of object vectors of all objects assigned to said each cluster.

In the above method, said updating comprises revising said centroid vector of said each cluster to equal a summation of said phase-specific vector sum and said cycle-specific vector sum divided by a total number of objects assigned to said each cluster upon completion of said each cycle.

According to one more aspect of the invention, there is provided a system for clustering a plurality of objects comprising:

a hardware processor and a memory device having computer executable instructions stored thereon for execution by the hardware processor, causing the hardware processor to:
obtain for every object of the plurality of objects a respective characterizing object vector;
initialize a singular affinity of said every object to exceed 1.0;
initialize a set of clusters of objects as empty sets;
assign a centroid with a respective centroid vector to each cluster of the set of clusters;
during each phase of successive phases, determine a phase-specific affinity threshold and actuate a predefined number of cycles performing for each cycle processes of:
   determining an affinity level of each object having a respective singular affinity below said phase-specific affinity threshold to said each cluster according to said respective characterizing object vector and said respective centroid vector; and
   assigning said each object to a specific cluster corresponding to highest affinity level.

In the system described above, the computer executable instructions, upon completion of said each cycle, further cause the processor to:
revise said respective singular affinity to equal said highest affinity level; and
update a centroid vector of said each cluster.

In the system described above, the computer executable instructions further cause the processor to:
preceding said each phase:
determine for said each cluster a respective phase-specific vector sum of object vectors of all objects assigned to said each cluster each having a respective singular affinity not less than said phase-specific affinity threshold; and
during said each cycle, determine for said each cluster a respective cycle-specific vector sum of object vectors of all objects assigned to said each cluster.

In the system described above, the computer executable instructions further cause the processor to revise said centroid vector of said each cluster to equal a summation of said phase-specific vector sum and said cycle-specific vector sum divided by a total number of objects assigned to said each cluster upon completion of said each cycle.

According to yet one more aspect of the invention, there is provided a method of clustering a plurality of objects comprising:

employing a hardware processor for:
obtaining for each object of the plurality of objects a respective characterizing object vector;
initializing a set of clusters of objects as empty sets;
assigning a centroid with a respective centroid vector to every cluster of the set of clusters;
during each phase of successive phases, determining for each cluster a respective phase-specific search domain applicable to constituent objects of said each cluster and actuating a predefined number of cycles performing for each cycle processes of:
   determining an affinity level of said each object to each neighboring cluster within a corresponding phase-specific search domain according to said respective characterizing object vector and a centroid vector of said each neighboring cluster; and
   assigning said each object to a specific cluster corresponding to highest affinity level.

The method further comprises, upon completion of said each cycle, updating a centroid vector of said each cluster.

The method further comprises:
setting said respective phase-specific search domain to be said set of clusters for an initial phase of said successive phases; and
upon completion of said each phase:
   determining an affinity level of said each cluster to each other cluster within said set of clusters;
   identifying for said each cluster neighboring clusters constituting said respective phase-specific search domain, each neighboring cluster having an affinity level exceeding a phase-specific affinity lower bound.

According to yet one more aspect of the invention, there is provided a system for clustering a plurality of objects comprising:

a hardware processor and a memory device having computer executable instructions stored thereon for execution by the processor, causing the processor to:
obtain for each object of the plurality of objects a respective characterizing object vector; initialize a set of clusters of objects as empty sets;
assign a centroid with a respective centroid vector to every cluster of the set of clusters; during each phase of successive phases, determine for each cluster a respective phase-specific search domain applicable to constituent objects of said each cluster and actuate a predefined number of cycles performing for each cycle processes of:
   determining an affinity level of said each object to each neighboring cluster within a corresponding phase-specific search domain according to said respective characterizing object vector and a centroid vector of said each neighboring cluster; and
   assigning said each object to a specific cluster corresponding to highest affinity level.

In the system described above, upon completion of said each cycle, the computer executable instructions further cause the processor to update a centroid vector of said each cluster.

In the above system, the computer executable instructions further cause the processor to:
set said respective phase-specific search domain to be said set of clusters for an initial phase of said successive phases; and
upon completion of said each phase:
   determine an affinity level of said each cluster to each other cluster within said set of clusters;
   identify for said each cluster neighboring clusters constituting said respective phase-specific search domain, each neighboring cluster having an affinity level exceeding a phase-specific affinity lower bound.

Thus, improved methods and systems for clustering a plurality of objects have been provided. Methods and systems of the present invention provide the following advantages: better selection of segmentation criteria that suit marketing objectives; more accurate grouping of objects of common traits; and significantly reducing the computational effort of finding optimal or near-optimal segmentation of objects by proper selection of search domains and by recognizing and avoiding redundant calculations.

### BRIEF DESCRIPTION OF THE DRAWINGS

Embodiments of the present invention will be further described with reference to the accompanying exemplary drawings, in which:

FIG. 1 illustrates a marketing system employing a marketing model configured to produce instructions for marketing steps based on segmented tracked data;

FIG. 2 visualizes a social graph of a population of tracked objects;

FIG. 3 illustrates clustering of the population into five clusters based on the radial K-means method;

FIG. 4 illustrates clustering of the same population into five clusters based on the angular K-means method;

FIG. 5 illustrates clustering of the same population into five clusters based on the composite K-means method in accordance with an embodiment of the present invention;

FIG. 6 illustrates an object represented by a multidimensional vector P and a centroid represented by a multidimensional vector C;

FIG. 7 illustrates an object and five centroids for use in an embodiment of the present invention;

FIG. 8 depicts values of angular-affinity measures, radial-affinity measures, and composite radial-angular affinity measures corresponding to the centroids of FIG. 7 in accordance with an embodiment of the present invention;

FIG. 9 depicts values of angular-affinity measures, alternate radial-affinity measures, and composite radial-angular affinity measures corresponding to the centroids of FIG. 7 in accordance with an embodiment of the present invention;

FIG. 10 depicts use of angular-affinity measures, radial-affinity measures, and composite radial-angular affinity measures based on the natural, rather than normalized, object vector P;

FIG. 11 illustrates a first implementation of the cluster-selection process with the composite radial-angular affinity measure in accordance with an embodiment of the present invention;

FIG. 12 illustrates a second implementation of the cluster-selection process with the composite radial-angular affinity index in accordance with an embodiment of the present invention;

FIG. 13 details a cluster-selection module of the implementation of FIG. 11, in accordance with an embodiment of the present invention;

FIG. 14 details processes of the implementation of FIG. 12, in accordance with an embodiment of the present invention;

FIG. 15 illustrates a recursive process of updating the centroids of the cluster, in accordance with an embodiment of the present invention;

FIG. 16 illustrates division of objects of a cluster into locked objects and free objects to reduce the computational effort for clustering massive data, in accordance with an embodiment of the present invention;

FIG. 17 illustrates a process of gradually designating candidate objects of a cluster as locked objects according to affinity levels, in accordance with an embodiment of the present invention;

FIG. 18 illustrates a method of implementing the method of FIG. 17;

FIG. 19 illustrates a representation of clusters of objects for use in determining a search domain for objects of each cluster, in accordance with an embodiment of the present invention;

FIG. 20 illustrates updating search domain for a cluster during successive centroid-update phases, in accordance with an embodiment of the present invention;

FIG. 21 illustrates processing effort during successive centroid-update phases for different clustering methods, in accordance with an embodiment of the present invention;

FIG. 22 illustrates formation of constellations of clusters based on generation of a plurality of independent sets of clusters, in accordance with an embodiment of the present invention;

FIG. 23 illustrates a mechanism for generating constellations of clusters, in accordance with an embodiment of the present invention;

FIG. 24 illustrates a plurality of independent sets of clusters, designating one set of clusters as constellations' seeds;

FIG. 25 illustrates an array of object processing data;

FIG. 26 illustrates two independent sets of clusters; and

FIG. 27 illustrates allocation of objects to constellations, in accordance with an embodiment of the present invention.

### DETAILED DESCRIPTION OF EMBODIMENTS OF THE INVENTION

A social graph is represented by tracked data relevant to users of a communication network in general and the Internet in particular. Noting that a communication network is not necessarily limited to serve human users, a tracked user is herein termed “an object” and is represented by a multidimensional vector quantifying a set of descriptors of the object.

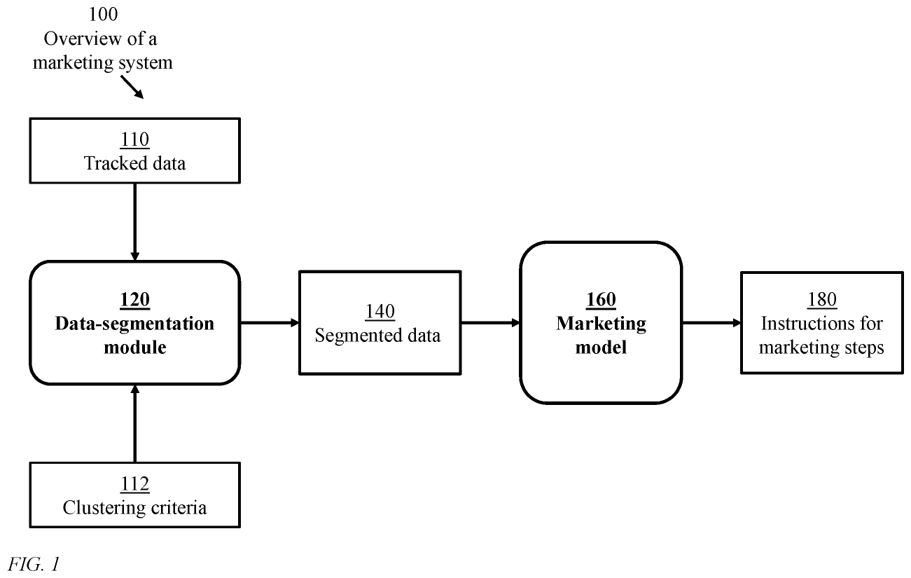

FIG. 1 illustrates a marketing system 100 employing a marketing model 160 configured to produce instructions 180 for marketing steps based on segmented tracked data. A data segmentation model 120 analyses tracked data 110 which may be acquired from a variety of sources, such as social networks, to produce segmented data according to prescribed clustering criteria 112.

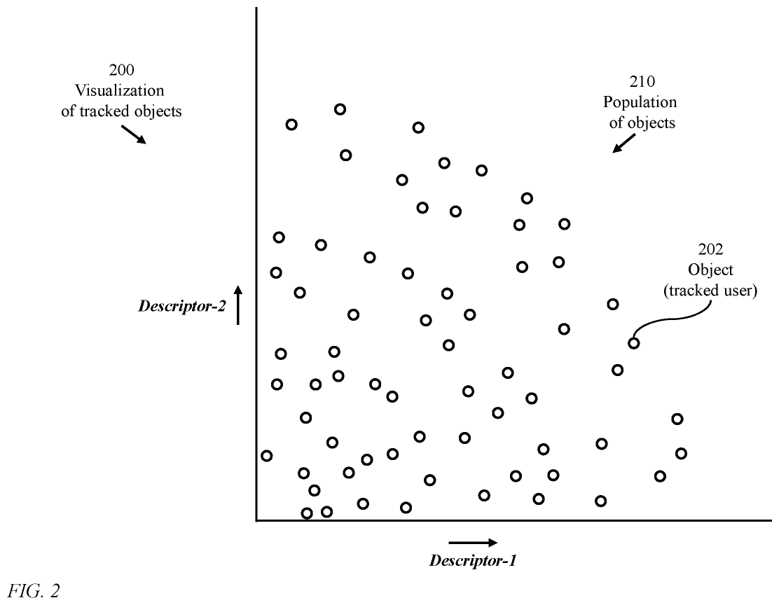

FIG. 2 is a visualization 200 of a scatter diagram of a population 210 of tracked objects 202, where each object is characterized according to only two descriptors. In general, each object may be characterized by an arbitrary number ν, ν>1, of descriptors and represented by a ν-dimensional vector. One of the popular methods of clustering the population of objects is the “K-means” method which groups objects of a population under consideration into a number K, K>1, of clusters. A centroid is determined for each cluster. The distance between an object and a cluster is defined as the distance between the object and the centroid of the cluster.

The K-means method is based on determining a distance, however defined, between an object and the centroids of the K clusters and associating the object with the nearest cluster. The number K is judicially selected. To realize statistically significant clustering, a lower bound, q, q>1, of the number of objects per cluster may be predefined. Thus, an upper bound of the number K may be determined as the ratio └N/q┘, N being the number of tracked objects. Initially, the clusters are empty sets and each cluster is associated with a respective centroid “seed”. Each object of the population is then assigned to one of the clusters and updated values of the K centroids are determined. Several cycles of assigning objects to clusters then updating the K centroids may take place until some convergence criterion is satisfied.

The values of the initial centroids may have a significant effect on the number of cycles needed. If the K initial centroids are too close to each other, the objects of any pair of clusters are likely to be spread, and interposed, over the global multidimensional space of the descriptors instead of being segregated. Consequently, the updated centroids would drift slowly towards steady-state values during successive update cycles. Thus, the initial values of the centroids are preferably selected to be distant from each other to realize fast convergence of an iterative centroid-refinement process.

The criterion of assigning an object to a cluster may be based on the radial (Euclidean) distances of the object to the K centroids or the angular displacements of the vector representing the object from the K vectors representing the centroids. The angle between a vector representing an object and a vector representing a centroid is a planer angle having values between 0 and π/2 radians. Since the cosine of an angle between 0 and π/2 is a monotone function of the angle, the cosine of the angle may be used for comparing angular-displacement values of an object from the K centroids. With all vectors representing the population of objects normalized to a magnitude of 1.0, the cosine of the angular displacement between any two vectors is simply the dot product of the two vectors.

Whether clustering is based on radial measures or angular measures, the descriptors may be individually normalized. For example, a descriptor representing the age of a tracked user may be normalized by dividing the age of each tracked user by the mean age or median age of the population under consideration (40 years for Canada and the U.S.A). Likewise, a descriptor representing annual income may be divided by the mean income of the population under considerations. The vectors representing the population of objects (tracked users), may further be normalized to a magnitude of 1.0 for specific purposes.

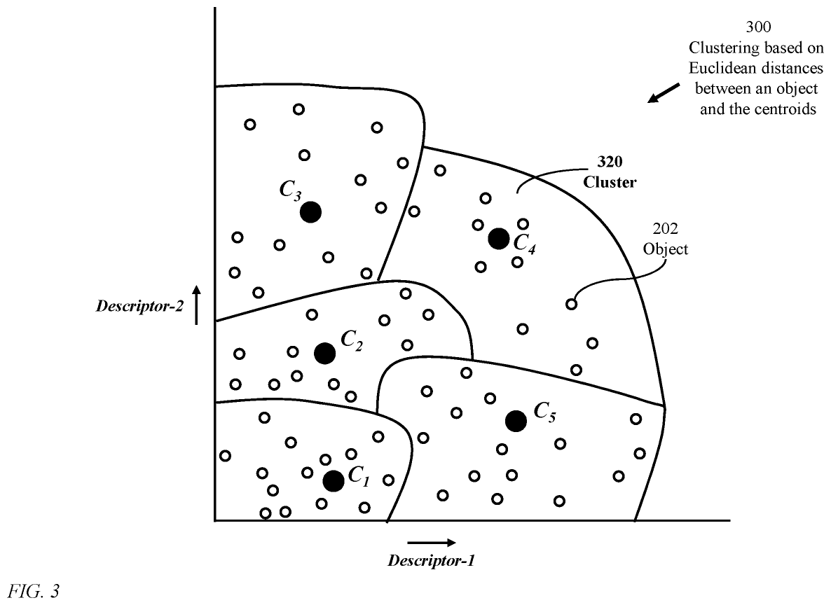

FIG. 3 illustrates clustering of the population 100 into five clusters (K=5) based on the radial K-means method. The Euclidean distance from an object of a particular cluster to the centroid of the cluster does not exceed the Euclidean distance from the object to the centroid of any other cluster.

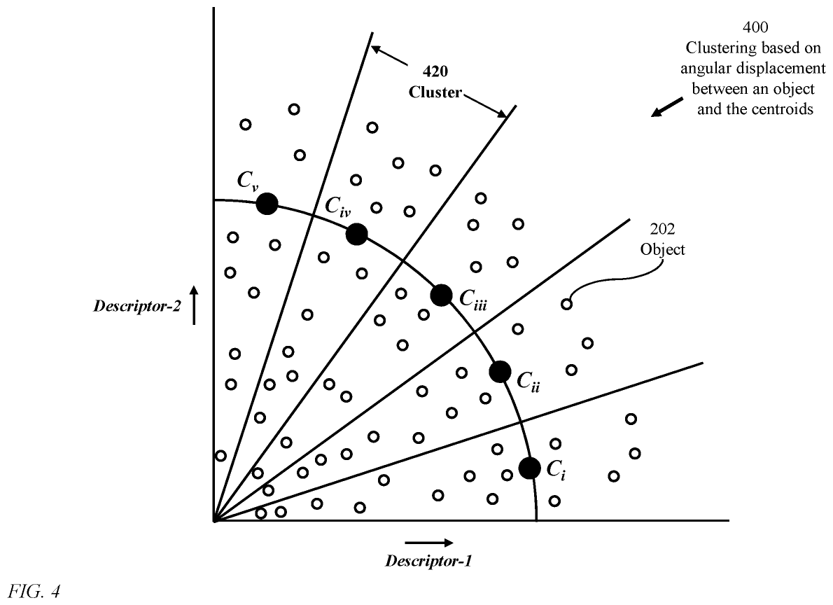

FIG. 4 illustrates clustering of the same population 100 into five clusters based on the angular K-means method (hyper-spherical K-means method) where the clustering process is based solely on the angle between an object and a centroid.

In accordance with the present invention, an object may be assigned to a cluster based on a composite measure of affinity which takes into account both the angular displacement and radial distance between the object and the centroid of the cluster.

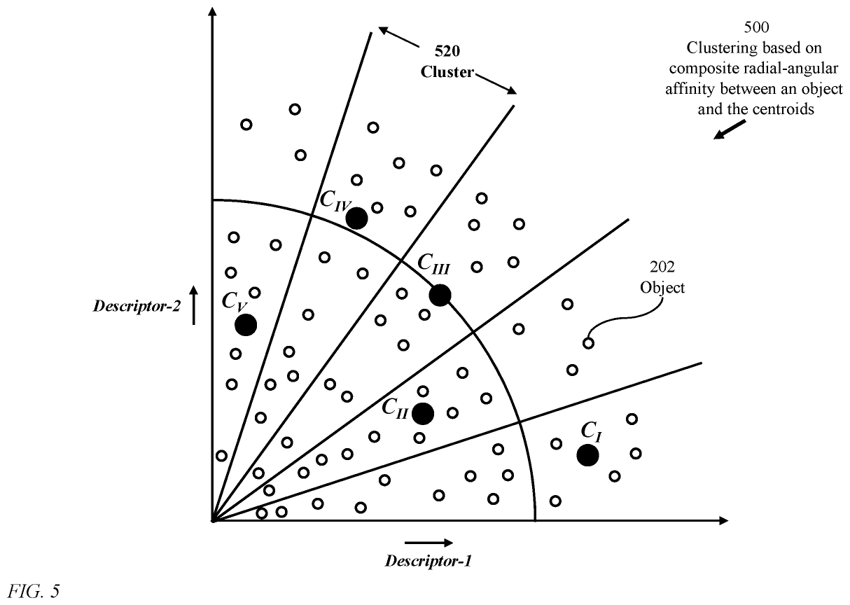

FIG. 5 illustrates clustering of the same population 100 into five clusters based on the composite K-means method.

### Affinity Computation

Consider a population of N objects, each object representing a tracked user and is represented by a ν-dimensional vector Pⱼ, 0≤j<N. The N objects are to be grouped into K clusters. The centroid of each cluster is represented by a ν-dimensional vector Cⱼ, 0≤j<K. Consider three clustering approaches:

Radial-affinity clustering;

Angular-affinity clustering; and

Composite radial-angular-affinity clustering.

Following selection of K initial-state centroids (K centroid seeds), two basic processes are iteratively performed regardless of the clustering criterion. The first process allocates each object to a cluster, and the second process refines the centroids.

The process of allocating objects to clusters entails N×K basic affinity computations with each basic affinity computation requiring at least ν multiplications and ν additions. The total number of multiplications is at least N×K×ν; naturally N>>K, and typically K>>ν. (For example: N=1000,000, K=100, ν=8.)

The process of refining the centroids entails N×ν additions and at least K×(ν+1) multiplications or divisions.

Thus, the process of allocating objects to clusters is by far more computationally intensive.

The distance between an object (vector P) and a cluster is defined as the distance between the object and the centroid (vector C) of the cluster. A normalized array C is denoted ć.

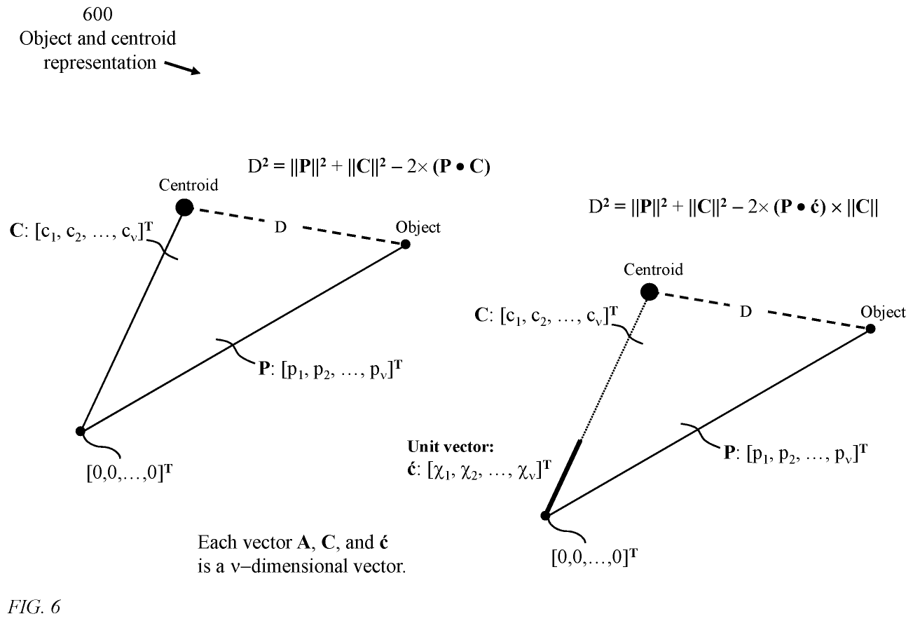

FIG. 6 illustrates an object represented by a ν-dimensional vector P and a centroid represented by a ν-dimensional vector C. As illustrated in FIG. 6:

Array [p₁, p₂, . . . , p_{ν}]T represents a ν-dimensional object vector P;

Array [c₁, c₂, . . . , c_{ν}]T represents a ν-dimensional centroid vector C; and

Array [χ₁, χ₂, . . . , χ_{ν}]^{T} represents a ν-dimensional normalized centroid vector \tilde{c}.

The cosine of the planar angle between the object vector P and the centroid vector C is determined from the scalar product of P and C:

P·C=p₁×c₁+p₁×c₁+ . . . +p_{ν}×c_{ν}.

If vectors P and C are normalized to a magnitude of unity, then the scalar product is the cosine of the angle. If only vector C is normalized, then the scalar product is the magnitude of vector P times the cosine of the angle. Since the magnitude of P is a common factor in the search for the nearest (most similar) centroid, normalizing the objects vectors would be unnecessary.

The square of the distance D between the object and the centroid may be determined as:

D²=(p₁−1)²+(p₁−c₁)²+ . . . +(p_{ν}−c_{ν})².

If ν is a large number, and if the scalar product P·C has already been computed, then D² may be determined from the identity:

D²=∥P∥²+∥C∥²−2×P·C.

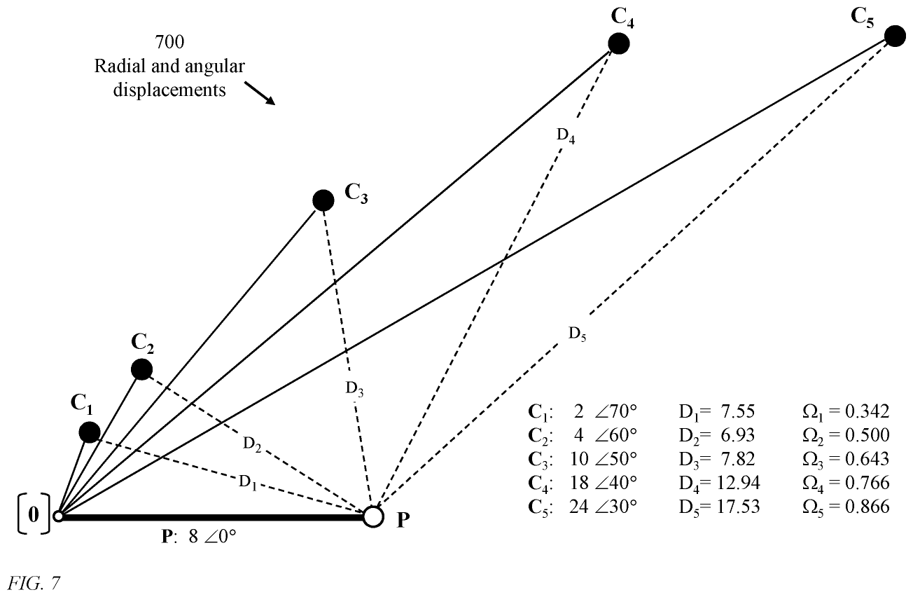

FIG. 7 illustrates an object and five centroids (K=5). The object is represented by a vector P. The computational requirements for the above clustering methods are compared below.

### Basic Affinity Computation

Consider a single centroid represented by ν-dimensional vector C.

Radial Affinity

(Vectors P and C are not Normalized)

D²=(p₁−c₁)²+(p₂−c₂)²+ . . . +(p_{ν}−c_{ν})²

(ν multiplications and 2×σ−1 additions or subtractions).

If the N objects are grouped according to objects' distances from centroids, then only the square of object-centroid distance need be determined.

Angular Affinity

(Vectors A is not normalized, vector C is normalized to

ć=(χ₁,χ₂, . . . ,χ_{ν})^{T},∥ć∥=1.0

A·c=p₁×χ₁+p₂×χ₂+ . . . +p_{ν}×χ_{ν}

(ν multiplications and σ−1 additions).

If the N objects are grouped according to objects' planar angles from centroids, then only the dot-product of object vector P and normalized centroid vector ć need be determined.

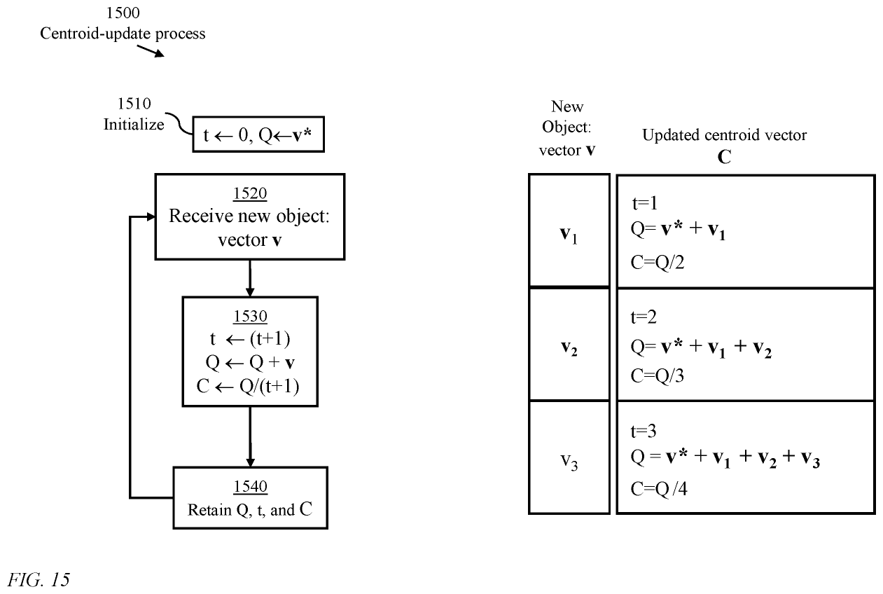

The ν descriptors are preferably normalized so that each descriptor has a mean value of 1.0 each. However, the objects' vectors need not be normalized to a magnitude of 1.0 since each object individually selects one of the K centroids based on comparing values of a monotone function of the angles. The monotone function may be the cosine function of an angle or the cosine function multiplied by ∥P∥. An updated centroid is a natural vector (not normalized) determined according to natural vectors of constituent objects of the cluster. Normalized centroid vectors are needed however to isolate the effect of the varying magnitudes of centroid vectors. Upon determining a normalized centroid vector from a natural centroid vector, the natural centroid vector is still retained to be used in a succeeding update. Updating a centroid is preferably performed as a recursive process that does not require processing all constituent objects as illustrated in FIG. 15.

Based on the angular-affinity criterion, selection of a cluster for an object is based only on vectors' directions.

The hybrid radial-angular clustering process requires determining both the angular affinity and radial affinity. The angular affinity is determined as the dot product of the object vector and normalized centroid as discussed above. The radial affinity is determined as a function of the Euclidean distance between the object and the natural centroid. Since the angular affinity P·ć has already been determined, the Euclidean distance can be determined based on the values ∥P∥², ∥C∥² which are retained for frequent use.

Hybrid Radial-Angular Affinity

(Vectors P is not normalized, vector C is normalized to

ć=(χ₁,χ₂, . . . ,χ_{ν})^{T}, ∥ć∥=1.0

A·ć=p₁×χ₁+p₂×χ₂+ . . . +p_{σ}×χ_{ν}

D²=∥P∥²+∥C²∥²−2×(P·ć)×∥C∥

(ν multiplications, ν+1 additions, 1 multiplication)

### (Alternative Computation) Hybrid Radial-Angular Affinity

(Vectors P and C are not normalized)

P·C=p₁×c₁+p₂×c₂+ . . . +ρ_{ν}×c_{ν}

D²=∥P∥²+∥C∥²−2×(P·C)

(ν multiplications, ν+1 additions, 1 division)

An object may be assigned to a cluster based on a composite measure of affinity which takes into account both the angular affinity and radial affinity of the object and the centroid of the cluster. Let Θⱼ, 0≤Θⱼ≤π/2, denote the angular displacement of an object P from centroid Cⱼ, and Dⱼ denote the radial distance from object P to centroid Cⱼ, 1≤j≤K. The angular affinity Ωj of the object to centroid Cⱼ may be defined as the cosine of Θⱼ which is bounded between 0.0 and 1.0. The distances from the object to the K centroids may vary significantly (even with descriptor normalization to a mean value of unity). It is desirable however to define a measure of radial affinity to be also bounded.

A first measure of radial affinity of the object P to a centroid Cⱼ may be determined as:

Δⱼ=∥P∥/(∥P∥+Dj).

Thus, Δⱼ=1.0 if Dⱼ=0.0 (for a centroid that coincides with the object in the ν-dimensional space). Δⱼ decreases as Dⱼ increases.

An affinity index Sⱼ reflecting both the angular affinity and radial affinity of an object to centroid Cⱼ may be defined as:

Sⱼ=α×Ωⱼ+β×δⱼ where 0.0≤α≤1.0, 0.0≤β≤1.0, α+β=1.

A second measure of radial affinity of the object P to a centroid Cⱼ may be determined as:

Δⱼ=(1−Dⱼ/D*) for Dⱼ≤D* and Δⱼ=0.0 for Dⱼ>D*;

where D* is the sum of the mean value μ and the standard deviation σ (or 2×σ) of the K radial distances between the object and the K centroids.

Thus, Δⱼ is bounded between 0.0 and 1.0, where a value of zero corresponds to a centroid of a radial distance from the object exceeding a predefined threshold and a value of 1.0 corresponds to a centroid that coincides with the object.

An affinity index Śⱼ reflecting both the angular affinity and radial affinity of an object to centroid Cⱼ may be defined as:

Śⱼ=α×Ωⱼ+β×Δⱼ

where α and β are weighting factors: 0≤α≤1.0, 0≤β≤1.0, and α+β=1.0.

FIG. 7 depicts a case where the number ν of object descriptors is two and number K of centroids is selected to equal five. An object is represented as a vector P of length ∥P∥=8.0. The angular affinity values Ω₁, Ω₂, Ω₃, Ω₄, and Ω₅ of the object to centroids C₁, C₂, C₃, C₄, and C₅ are determined as 0.342, 0.500, 0.643, 0.766, and 0.866. The distances D₁, D₂, D₃, D₄, and D₅ between the object and the five centroids are 7.55, 6.93, 7.82, 12.94, and 17.53.

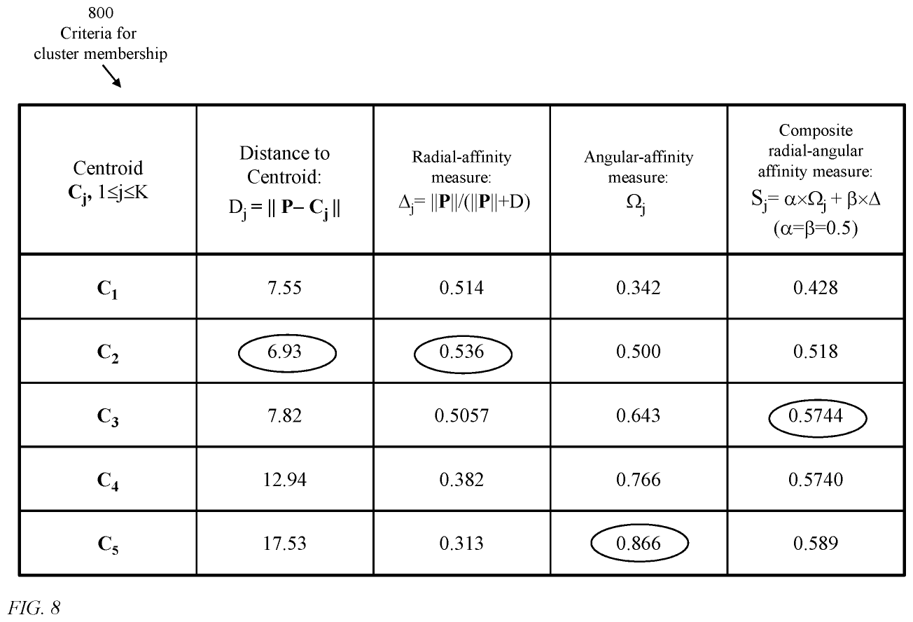

FIG. 8 depicts values of radial affinity measures {Δ₁, Δ₂, Δ₃, Δ₄, Δ₅}, based on the first measure of radial affinity, and angular-affinity measures {Ω₁, Ω₂, Ω₃, Ω₄, Ω₅} corresponding to the centroids of FIG. 7. The composite similarity indices {S₁, S₂, S₃, S₄, S₅} are determined for α=β=0.5. According to the radial distances (or radial-affinity measures), object P would be assigned to the cluster associated with centroid C₂. According to the angular-affinity measures, object P would be assigned to the cluster associated with centroid C₅. According to the composite radial-angular-affinity measure based on the first measure of radial affinity, object P would be assigned to the cluster associated with centroid C₃.

The mean value μ and standard deviation σ of the distances D₁ to D₅ are 10.55 and 4.11, respectively. Thus, D*, selected as μ+σ, equals 14.66. The measures of radial affinity Δ₁, Δ₂, Δ₃, Δ₄, and Δ₅ are then determined as 0.485, 0.527, 0.466, 0.117, and 0.0.

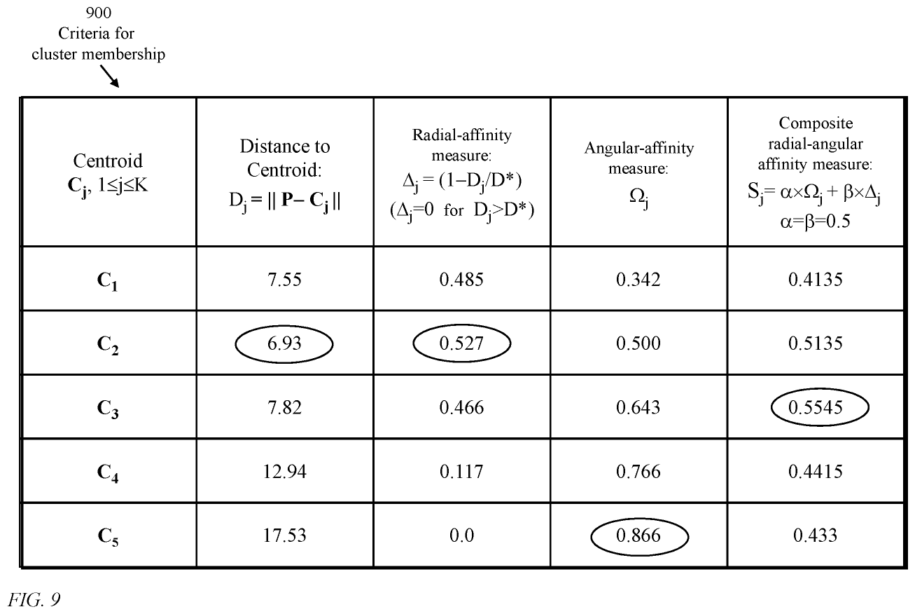

FIG. 9 depicts values of radial-affinity measures {Δ₁, Δ₂, Δ₃, Δ₄, Δ₅}, based on the second measure of radial affinity, and angular-affinity measures {Ω₁, Ω₂, Ω₃, Ω₄, Ω₅} corresponding to the centroids of FIG. 7. As in the case of FIG. 8, object P would be assigned to the cluster associated with centroid C₃ based on the composite radial-angular-affinity measures.

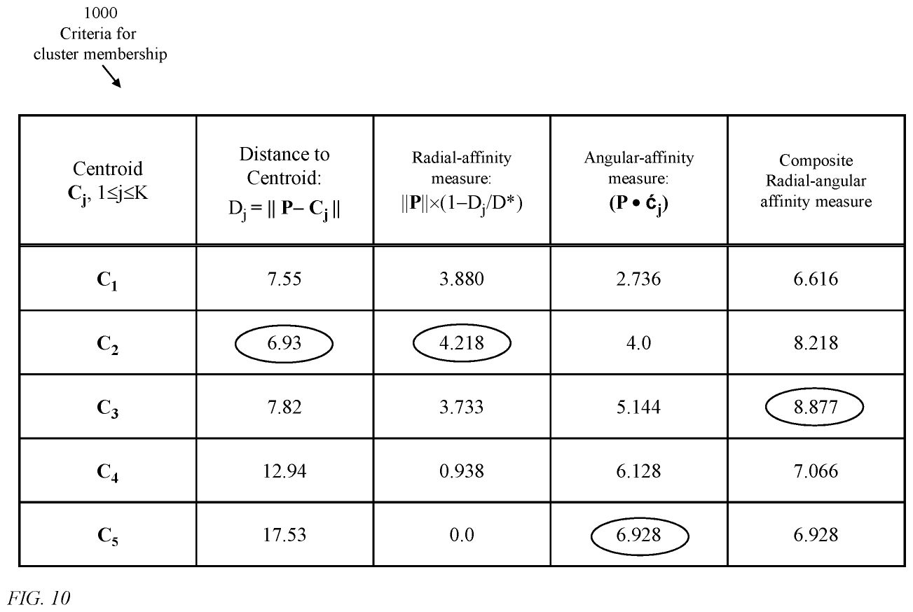

FIG. 10 depicts use of radial-affinity measures, based on the first measure of radial affinity, and angular-affinity measures based. The affinity measures are not normalized.

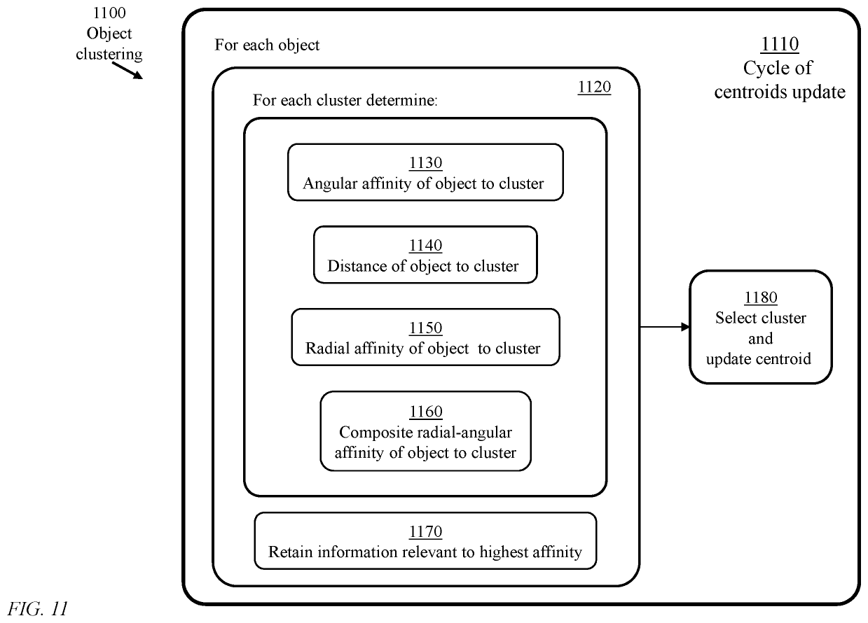

FIG. 11 illustrates a first implementation of the cluster-selection process with the composite radial-angular affinity index determined as:

Sⱼ=α×Ωⱼ+β×δⱼ, 0≤α≤1.0, 0≤β≤1.0, and α+β=1.0

δⱼ=∥P∥/(∥P∥+Dⱼ), 0≤j<K.

The assignment of objects to clusters is determined in an iterative execution of a global computation cycle 1110. In a global computation cycle, a cluster-selection procedure 1120 is executed to select a cluster for each object, assign the object to the selected cluster, and then update the centroid of the selected cluster.

The cluster-selection procedure 1120 comprises applying for each of the K clusters processes of:
determining the object's angular-affinity to a cluster under consideration (process 1130);
determining the object's distance to the cluster under consideration (process 1140);
determining the object's radial-affinity measure with respect to the cluster under consideration (process 1150); and
determining the composite radial-angular similarity measure for the cluster under consideration (process 1160).

The value of the composite radial-angular similarity measure may be retained for each cluster if the process of selecting a preferred cluster for the object takes into consideration other factors. Otherwise, only one composite radial-angular affinity measure is retained (process 1170) based on comparison of results relevant to successive clusters.

Upon completion of the cluster-selection procedure 1120 for all of the K clusters, a cluster is selected. The centroid of the selected cluster is then updated (process 1180) as illustrated in FIG. 15.

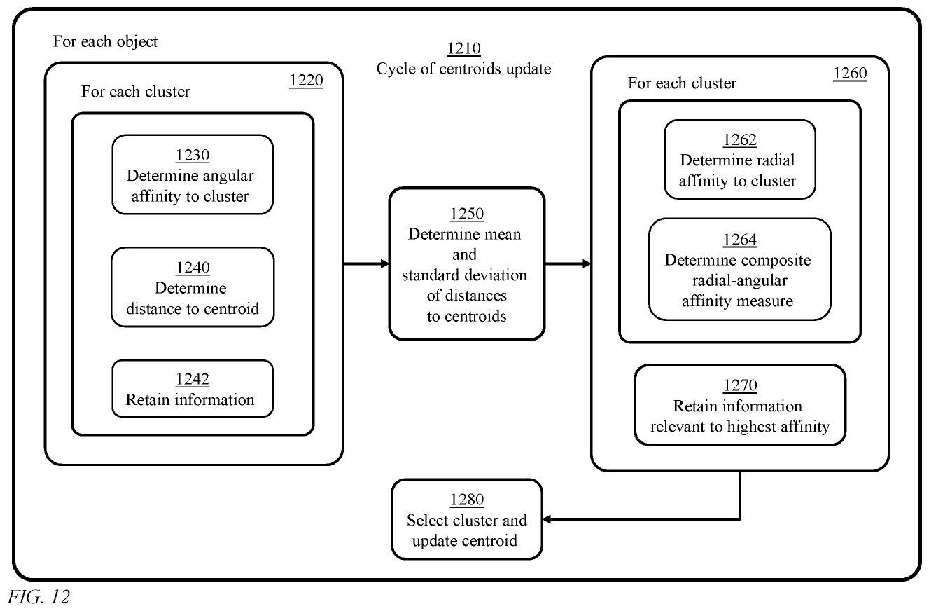

FIG. 12 illustrates a second implementation of the cluster-selection process with the composite radial-angular affinity index determined as:

Śⱼ=αΩⱼ+β×Δⱼ, 0≤α≤1.0, 0≤β≤1.0, and α+β=1.0.

Δⱼ=(1−Dⱼ/D*) for Dⱼ≤D* and Δⱼ=0.0 for Dⱼ>D*;

where D* is the sum of the mean value μ and the standard deviation σ of the K radial distances {D₁, D₂ . . . D_{K}} between the object and the K centroids. The value of D* may be selected according to other criteria.

The assignment of objects to clusters is determined in an iterative execution of a global computation cycle 1210. In a global computation cycle, process 1220 is applied to determine for each of the K clusters:
the object's angular-affinity Ωⱼ to a cluster of index j, 1≤j≤K, under consideration (process 1230); and
the object's distance Dⱼ to the cluster under consideration (process 1240).

The values Ωⱼ and Dⱼ are retained for each cluster (process 1242). Upon determining Dⱼ for all clusters (1≤j≤K), the mean value μ and the standard deviation σ of the K radial distances {D₁, D₂, . . . , D_{K}} between the object and the K centroids can be determined (process 1250). With D* defined as D*=μ+σ (or generally D*=μ+h×σ, h being a positive real number), the radial-affinity measure Δⱼ can be determined for each cluster j.

Cluster-selection procedure 1260 comprises applying for each of the K clusters processes of:
determining the object's radial-affinity measure with respect to the cluster under consideration (process 1262); and
determining the composite radial-angular affinity measure for the cluster under consideration (process 1264).

The value of the composite radial-angular affinity measure may be retained for each cluster if the process of selecting a preferred cluster for the object takes into consideration other factors. Otherwise, only one composite radial-angular affinity measure is retained (process 1270) based on comparison of results relevant to successive clusters.

Upon completion of the cluster-selection procedure 1260 for all of the K clusters, a cluster is selected and the centroid of the selected cluster is updated (process 1280) as illustrated in FIG. 15.

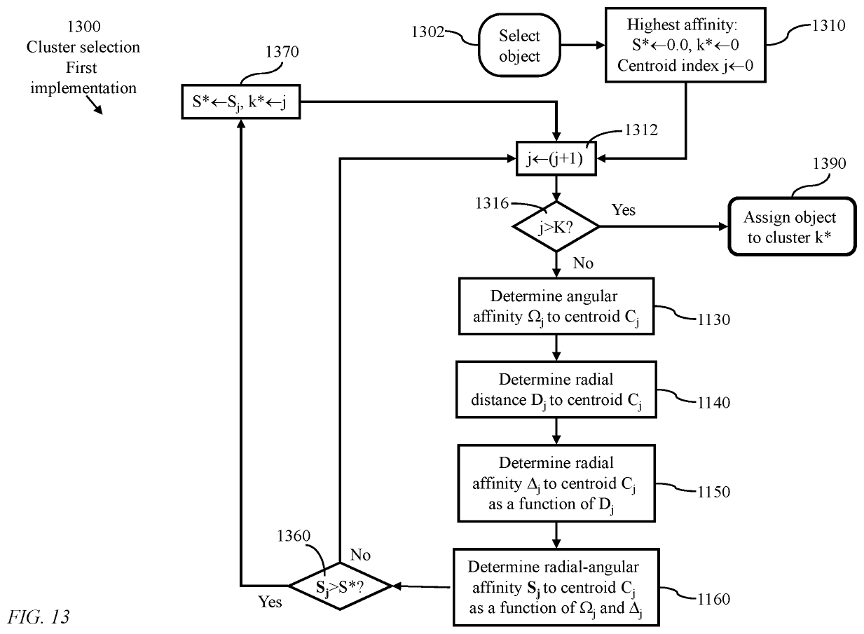

FIG. 13 details the cluster-selection procedure 1120 of FIG. 11. The N objects are considered sequentially. Upon selecting an object (process 1302), an initial value of the highest affinity measure S* is set to 0.0, the index k* of the cluster of highest affinity measure is initialized as a null value (0 for example), and the index j of the candidate cluster is set to equal 0 (process 1310). An index j of a candidate cluster of centroid Cⱼ is updated in step 1312. If the index exceeds the total number K of clusters, the cluster-selection process is considered complete (step 1316) and the object under consideration is assigned to the selected cluster (step 1390).

Processes 1130, 1140, 1150, and 1160 described with reference to FIG. 11 are then executed.

Process 1130 determines the angular affinity Ωⱼ of the object to centroid Cⱼ. The centroid vector Cⱼ is normalized to a magnitude of unity. The resulting normalized centroid vector c is denoted:

ć=(χ₁,Ω₂, . . . ,χ_{ν})^{T},∥ć∥==1.0.

The angular-affinity measure Ωⱼ is determined as:

Ωⱼ=P·ć=p₁×χ₁+p₂×χ₂+ . . . +p_{ν}×χ_{ν}.

Process 1140 determines the radial distance Dⱼ from the object to centroid Cⱼ. The square of distance may be determined from the Cartesian representation of the object vector P and the candidate-centroid vector as:

D²=(p₁−c₁)²+(p₂−c₂)²+ . . . +(p_{ν}−c_{ν})².

However, where ν>>1, and since the values of ∥P∥2, ∥Cⱼ∥², ∥Cⱼ∥, and P·ć have already been determined, the square of the distance may be determined as:

D²=∥P∥²+∥C∥²−2×(P·ć)×∥C∥.

Process 1150 determines the radial affinity as:

δⱼ=∥P∥/(∥P∥+Dj), 0≤j<K.

Process 1160 determines the composite radial-angular affinity measure as:

Sⱼ=Ωⱼ+β×δⱼ, where β (β>0.0) is a design parameter.

The currently computed value Sⱼ is compared with the last encountered highest value S*. If Sⱼ is less than or equal to S* (step 1360), a subsequent cluster, if any, is considered (step 1312) as a new candidate. Otherwise, if Sⱼ is larger than S* (step 1360), the index k* of the optimal centroid is set to equal the index j of the current candidate cluster, the value S* is set to equal Sⱼ (step 1370), and a subsequent cluster, if any, is considered (step 1312) as a new candidate.

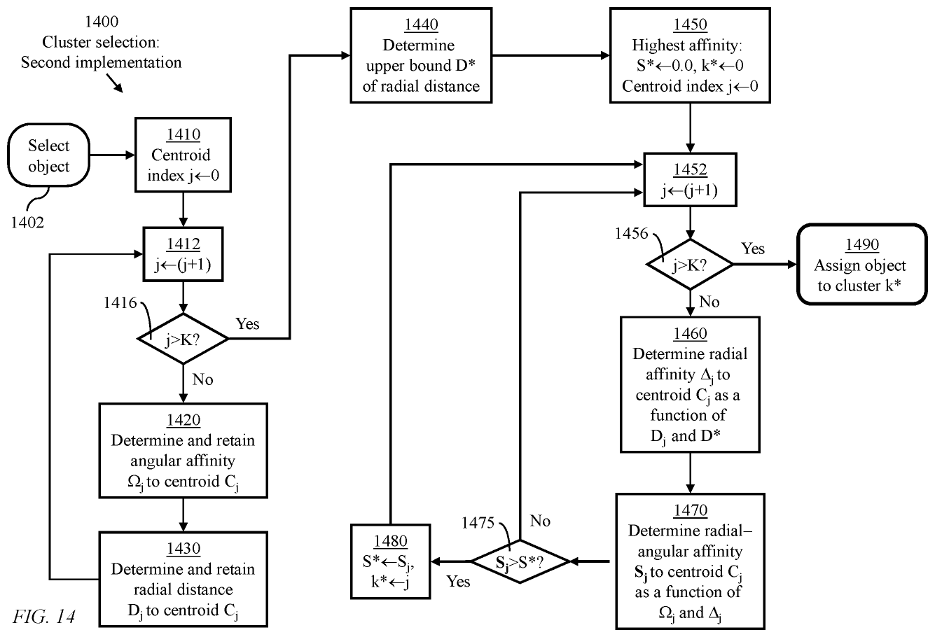

FIG. 14 details processes 1220 and 1260 of FIG. 12. The N objects are considered sequentially. Processes 1420 and 1430 correspond to process 1220 of FIG. 12 while processes 1460, 1470, and 1480 correspond to process 1260 of FIG. 12.

Upon selecting an object (process 1402), the index j of the candidate cluster is set to equal 0 (process 1410). An index j of a candidate cluster of centroid Cⱼ is updated in step 1412. If the index exceeds the total number K of clusters, the computation of the radial distances between the object and the K centroids is considered complete and process 1440 is executed to determine an upper bound of a radial distance.

Process 1420 determines the angular affinity Ωⱼ of the object to centroid Cⱼ according to the steps of process 1130 of FIG. 13. The only difference is that process 1420 retains the computed value of Ωⱼ for further use.

Process 1430 determines the radial distance Dⱼ from the object to centroid Cⱼ according to the steps of process 1140 of FIG. 13. The only difference is that process 1430 retains the computed value of Dⱼ for further use in processes 1440, and 1460.

Process 1440 determines the mean value μ and the standard deviation σ of the K radial distances {D₁, D₂, . . . , D_{K}} between the object and the K centroids. With D* defined as D*=μ+σ (or D*=μ+h×σ, h>0.0), the radial-affinity measure Δⱼ can be determined for each cluster j (process 1460).

An initial value of the highest affinity measure S* is set to 0.0, the index k* of the cluster of highest affinity measure is initialized as a null value (0 for example), and the index j of the candidate cluster is set to equal 0 (process 1450). An index j of a candidate cluster of centroid Cⱼ is updated in step 1452. If the index exceeds the total number K of clusters, the cluster-selection process is considered complete (step 1456) and the object under consideration is assigned to the selected cluster (step 1490).

Process 1460 determines the radial affinity as:

Δⱼ=(1−D/D*) for Dⱼ≤D* and Δⱼ=0.0 for Dⱼ>D*;

where D* is the sum of the mean value μ and the standard deviation σ, or μ+(2×σ), of the K radial distances {D₁, D₂ . . . D_{K}} between the object and the K centroids as determined in process 1440.

Process 1470 determines the composite radial-angular affinity measure as:

Sⱼ=α×Ωⱼ+β×Δⱼ, where 0.0≤α≤1.0, 0.0≤β≤1.0, α+β=1.

The currently computed value Sⱼ is compared with the last encountered highest value S*. If Sⱼ is less than or equal to S* (step 1475), a subsequent cluster, if any, is considered (step 1452) as a new candidate. Otherwise, if Sⱼ is larger than S* (step 1475), the index k* of the optimal centroid is set to equal the index j of the current candidate cluster and the value S* is set to equal Sⱼ (step 1480) and a subsequent cluster, if any, is considered (step 1452) as a new candidate.

### Centroid Updating

At the beginning of each global computation cycle, each cluster contains a single hypothetical centroid which would be a seeded value at the start of the first global computation cycle or a computed centroid of objects assigned to the cluster in a previous global computation cycle. The centroid seeds of the K clusters are judicially selected as described above.

To determine an updated value of the centroid based on the newly assigned object, a straightforward approach is to retain pointers to vectors representing the objects so far assigned to the cluster and determine the centroid vector after each new allocation to the cluster as the mean value of the accumulated object vectors. However, this would be computationally intensive for clusters of large object memberships. Alternatively, the centroid vector may be determined recursively as described below.

Initially, the cluster is empty but is assigned a vector v* which may be a centroid seed or a centroid vector determined in a previous global computation cycle. The value of an update counter of a cluster is denoted “t”; initially, t=0 and a vector sum Q is set to equal v*. The update counter assumes values t of 1, 2, . . . for subsequent assignments of object vectors v₁, v₂, . . . to the cluster.

The centroid vector C of a cluster is determined recursively. With initial values t←0 and Q←v*, the value of C at t=1, when an object vector v₁ is added to the cluster is determined as (ν* +v₁)/2, and the value of C at t=2 when an object vector v₂ is added to the cluster is determined as (ν* +v₁+v₂)/3, and so on. Thus, with each addition of a vector v to the cluster, the value of C can be determined from the recursion:

t←(t+1);

Q←(Q+v); and

C←Q/(t+1).

FIG. 15 illustrates a process 1500 of updating the centroid of a cluster according to the above recursion. With “t” denoting a number of objects of the cluster under consideration, and “Q” denoting the sum of object descriptor vectors, process 1510 sets an initial value of t as 0 and an initial value of Q as a vector v* representing a centroid seed. It is noted that a centroid seed is not a member of a cluster. Process 1520 receives a pointer to an object assigned in process 1390 (FIG. 13) or process 1490 (FIG. 14). Process 1530 determines an updated centroid according to the above recursion. Process 1540 retains the current update count and the current centroid vector for further use.

The processes illustrated in FIGS. 11 to 14, as applied to a social graph of a vast population, are computationally intensive requiring the use of at least one hardware processor. A variety of processors, such as microprocessors, digital signal processors, and gate arrays, may be employed. Generally, processor-readable media are needed and may include floppy disks, hard disks, optical disks, Flash ROMS, non-volatile ROM, and RAM.

Thus, invention provides a method of clustering a plurality of objects according to a clustering criterion. The method comprises configuring at least one hardware processor to perform processes of generating a set of K centroids, K>1, assigning each centroid to a respective cluster of a set of K clusters, then assigning objects, selected in a predetermined order, to one of the clusters based on an affinity measures to the clusters. For a selected object, the method performs processes of evaluating a composite affinity measure to each centroid of the K centroids based on a radial-affinity measure and an angular-affinity measure and identifying a particular centroid of highest composite affinity measure. The selected object is then assigned to a particular cluster corresponding to the particular centroid and the particular centroid is updated to account for inclusion of the selected object. Identifiers of objects assigned to each cluster are stored for use in a marketing model.

Each object is characterized by a respective vector of descriptors. Updating the particular centroid comprises steps of maintaining a count of current objects assigned to the particular cluster, maintaining a vector sum of vectors of descriptors of the current objects, and determining an updated centroid as the vector sum divided by the count of current objects

Optionally, each object may be assigned a respective weight and the predetermined order of allocating objects to respective clusters is selected as a descending order according to weight.

A cycle of allocating each object to a respective centroid may be repeated until the centroids are stabilized. A large number of cycles may be actuated. Preferably, the predetermined order of selecting objects for allocation to a cluster differs from one cycle to another. For each cycle generating a respective pseudo-random sequence of different integers is generated. The integers correspond to memory addresses of vectors of descriptors of the plurality of objects. Thus, the predetermined order is established according to the respective pseudo-random sequence.

The method further comprises steps of maintaining object-assignment records indicating for each object an identifier of a cluster to which each object is assigned as well as a corresponding composite affinity measure.

Optionally, several initial cycles of allocating each object to a respective centroid are actuated for all objects of the plurality of objects then several succeeding cycles of allocating objects to respective centroids are actuated for only each object of a composite affinity measure below a specified level.

The method further comprises determining an overall number of changes of object assignments to clusters during a cycle of allocating each object to a respective centroid.

While a ratio of the overall number of changes to a total number of objects of the plurality of objects exceeds a predefined threshold, the cycle of allocating each object to a respective centroid is repeated. The number of actuating the cycle may be limited to a predefined number.

Preferably, each of the radial-affinity measure, the angular-affinity measure, and the composite affinity measure is determined as a normalized value bounded between 0 and 1.0.

According to a first implementation of the cluster-selection process, the angular affinity measure of an object to a centroid is determined as a dot product of vectors (C/∥C∥) and (P/∥P∥), the radial affinity measure of the object to the centroid is determined as a ratio ∥P∥/(∥P∥+D), and the composite affinity measure is a weighted sum of the angular affinity measure and the radial affinity measure, where C denotes a centroid vector of the centroid, P denotes an object vector of the object, ∥C∥ denotes magnitude of C, ∥P∥ denotes magnitude of P, and D denotes the Euclidean distance (P−C)∥.

According to a second implementation of the cluster-selection process, the angular affinity measure of an object to a centroid is determined as a dot product of vectors (C/∥C∥) and (P/∥P∥), the radial affinity measure of the object to the centroid is determined as a ratio F defined as F=(1−D/D*) for D<D* and F=0 otherwise, and the composite affinity measure is a weighted sum of the angular affinity measure and the radial affinity measure; where C denotes a centroid vector of the centroid, P denotes an object vector of the object, ∥C∥ denotes magnitude of C, ∥P∥ denotes magnitude of P, and D denotes the Euclidean distance (P−C)∥, and D* is a predefined distance threshold, D*>0.

### Avoiding Redundant Search

The clustering method described above with reference to FIG. 11 to FIG. 14 is based on repetitive actuation of several cycles 1110 or 1210 of centroid update where in each cycle a search for a cluster of highest affinity is performed for each object. During successive cycles, the content of a particular cluster may change with some objects remaining in the particular cluster, other objects migrating to other clusters, and objects from other clusters joining the particular cluster. In accordance with an embodiment of the present invention, the computational effort may be reduced by avoiding continued search for objects deemed to be stabilized within the particular cluster.

### First Method of Expediting Clustering Processes

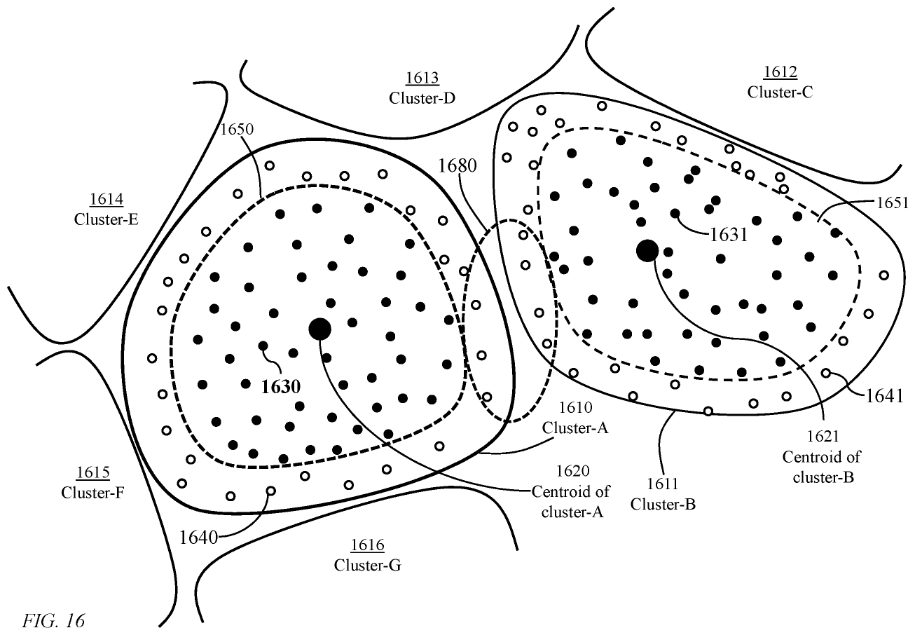

FIG. 16 illustrates a set of clusters 1610, 1611, 1612, 1613, 1614, 1615, and 1616 of objects grouped according to specific clustering criteria. The clusters are formed starting with a set of centroid seeds and the contents of the individual clusters are gradually adjusted. To initialize a first cycle, each cluster is assigned a respective centroid seed but the clusters are empty; none of the objects is preassigned to a cluster. During the first cycle, each object is assigned to a cluster of highest respective affinity. With each object assignment to a specific cluster, the centroid of the centroid of the specific cluster is refined to account for the added object. Thus, upon completion of the first cycle, the centroids may shift considerably because the centroid seeds are selected without knowledge of forthcoming content. Several cycles of centroids update are actuated until a converge criterion is met. Conventional clustering methods are based on determining affinity levels of each object to each cluster during each cycle since the centroids are likely to shift. It is plausible, however, that the centroids shift decreases as more cycles are executed and, consequently, a significant proportion of objects may not change cluster membership after completion of a moderate number of cycles. It is also plausible that the proportion of objects of unchanging cluster membership increases with the increase of the number of cycles. An object that does not migrate to a different cluster after completion of a certain number of cycles is herein referenced as a “locked object” while an object that is susceptible to migration to a different cluster is referenced as a “free object”. Thus, the objects of each cluster may be divided into locked objects and free objects with the proportion of locked objects increasing as more cycles are completed. As illustrated, after completion of a certain number of cycles, the objects of cluster 1610 may be divided into locked objects 1630 and free objects 1640, the locked objects 1630, within boundary 1650, having a relatively higher level of affinity to the centroid 1620 of cluster 1610. Likewise, the objects of a neighboring cluster 1621 may be divided into locked objects 1631, within boundary 1651, and free objects 1641, the locked objects 1631 having a relatively higher affinity level to the centroid 1621 of cluster 1611. Free objects 1640 of cluster 1610 and 1641 of cluster 1611 may change cluster membership during a current cycle. For example, some of set 1680 of free objects may change membership from cluster 1610 to cluster 1611, or vice versa.

The tendency of object natural division into locked objects and free objects may be exploited to reduce the computational effort for clustering massive data. With the actuation of numerous cycles, gradual designation of a number of objects as locked objects reduces the computation effort.

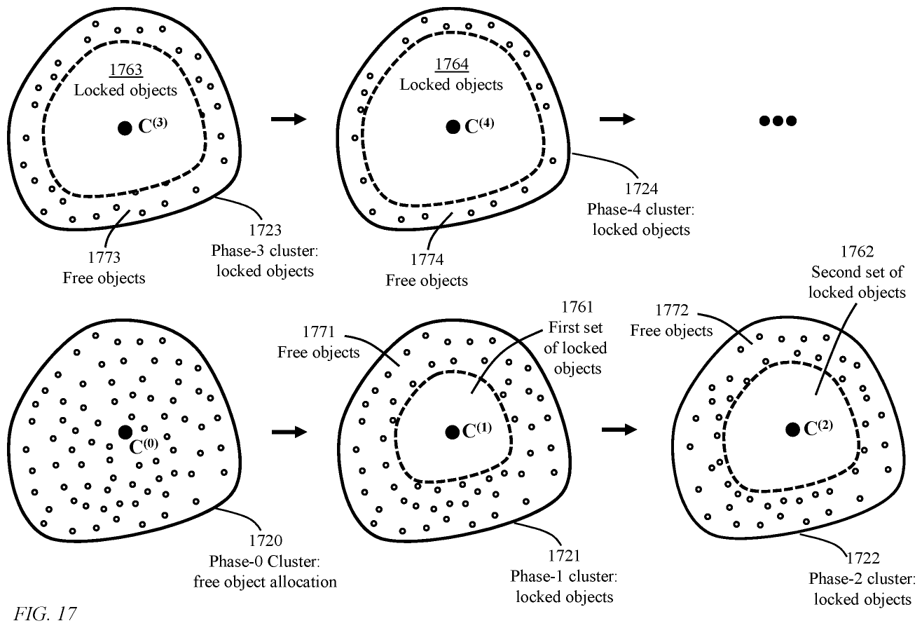

FIG. 17 illustrates a process of gradually designating candidate objects of an exemplary cluster as locked objects according to affinity levels over a number of phases labeled phase-0, phase-1, etc. A phase corresponds to a respective number of consecutive cycles; for example, each phase may cover five cycles. During each cycle of phase-0, 1720, all objects of the cluster are considered free objects. Thus, the affinity level of each object of the cluster to each of K centroids is computed to find a cluster of respective highest affinity. The centroid C⁽⁰⁾ may shift during each cycle of phase-0.

During each cycle of phase-1, 1721, the content of the cluster is divided into a set 1761 of locked objects and a set 1771 of free objects. During each cycle of phase-1, the affinity level of each object of the set 1771 of free objects to each of K centroids is determined. The centroid C⁽¹⁾ may shift during each cycle of phase-1.

Likewise, during each cycle of phase-2, 1722, the content of the cluster is divided into a set 1762 of locked objects and a set 1772 of free objects. During each cycle of phase-2, the affinity level of each object of the set 1772 of free objects to each of K centroids is determined. The proportion of locked objects during phase-2 is higher than the proportion of locked objects during phase-1. The centroid C⁽¹⁾ may shift during each cycle of phase-2.

The trend continues during phase-3, 1723, phase-4, 1724, etc., where the proportion of locked objects (1763, 1764, . . . ) continues to increase and affinity levels to K-centroids are computed for only free objects (1773, 1774, . . . ).

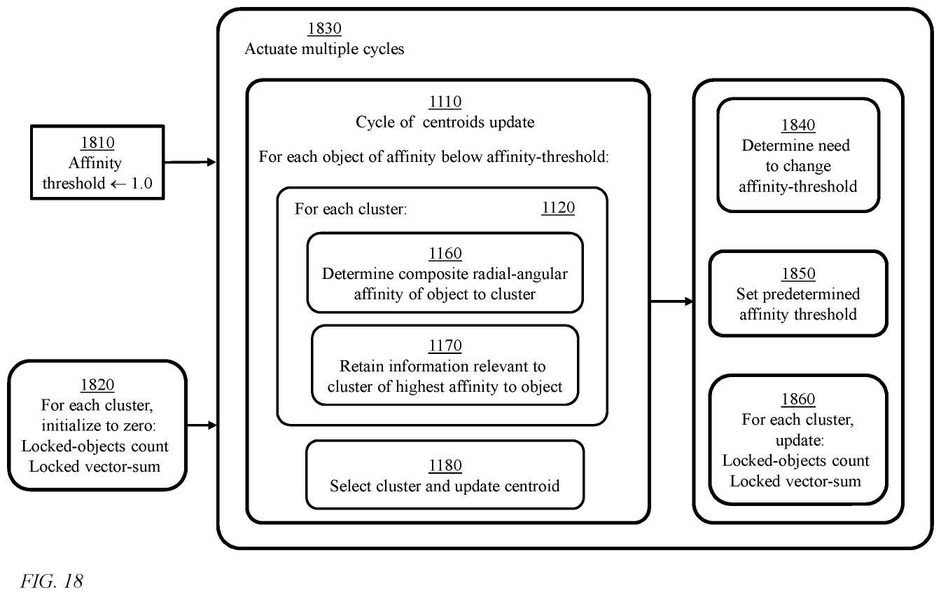

FIG. 18 illustrates a method of implementing the method of FIG. 17. Initially, a global affinity threshold 1810 is set to equal 1.0. For each cluster, a locked-object count is set to zero and a locked vector-sum 1820 is set to 0.0. A cycle 1110 of centroid update, as described above with reference to FIG. 11, is actuated repeatedly (reference 1830) until a converge criterion is satisfied.

During a first phase covering a number of cycles (the first five cycles for example), the initial global affinity threshold of 1.0 is maintained. Thus, every object in every cluster is considered a free object and is allowed to look for a better cluster; an object is considered a free object only if its computed affinity to a respective cluster is less than a current value of the global affinity threshold. At the end of each cycle, the affinity threshold may be modified.

During each of subsequent phases, each phase covering a respective number of cycles, the global affinity threshold is reduced according to a predetermined rule. For example, the global affinity threshold may be multiplied by 0.8 for each new phase. A flexible means is to provide an array of global affinity thresholds where each entry corresponds to a cycle index. For example, phase-0 may cover cycles of indices 0 to 4, phase-1 may cover cycles of indices 5 to 9, and so on as indicated in the table below.

| | | | | | | | | | | | | | | | | | |
|---|---|---|---|---|---|---|---|---|---|---|---|---|---|---|---|---|---|
| Cycle index | 0 | 1 | 2 | 3 | 4 | 5 | 6 | 7 | 8 | 9 | 10 | 11 | 12 | 13 | 14 | 15 | 16 |

| | | | | |
|---|---|---|---|---|
| Global Affinity | 1.0 | 0.8 | 0.7 | . . . |
| threshold | | | | |

Thus, following each cycle, process 1840 determines if the global affinity threshold is to be updated. If an update is due, process 1850 determines a new global affinity threshold either according to a rule, such as assigning a value based on cycle index according to a predetermined formula, or by indexing an array similar to the exemplary array above.

With an update of the global affinity threshold, process 1860 is actuated to determine for each cluster a respective count (“locked object count, denoted L*”) of the number of objects to be locked to respective clusters and a respective sum of descriptor vectors of all locked objects (“Locked vector sum, denoted Q*”. These values will be used in process 1180 to determine updated centroids. With each new cycle 1110 of the multiple cycles of FIG. 18, process 1180 applies process 1500 with initial values {t←L* and Q←Q*} instead of {t←0 and Q←v*).

### Second Method of Expediting Clustering Processes

The clustering method described above with reference to FIG. 11 to FIG. 14 is based on repetitive actuation of several cycles 1110 or 1210 of centroid update where in each cycle a search for a cluster of highest affinity is performed for each object. The clustering method illustrated in FIG. 18 reduces the computational effort by avoiding continued search for objects deemed to be stabilized within the particular cluster. Further reduction of the computation effort may be realized by proper selection of search domains as described below.

Thus, the invention provides a method of clustering a plurality of objects comprising: determining for every object of the plurality of objects a respective characterizing object vector; initializing a singular affinity of every object to exceed 1.0; initializing a set of clusters of objects as empty sets; and assigning a centroid with a respective centroid vector to each cluster of the set of clusters.

During each phase of successive phases, a phase-specific affinity threshold is determined and a predefined number of cycles is actuated, performing for each cycle processes of: determining an affinity level of each object having a respective singular affinity below the phase-specific affinity threshold to each cluster according to the respective characterizing object vector and the respective centroid vector; and assigning said each object to a specific cluster corresponding to highest affinity level.

Upon completion of each cycle the singular affinity of each object is revised to equal a corresponding highest affinity level and the centroid vector of each cluster is updated.

For each cluster, and preceding each phase, a respective phase-specific vector sum of object vectors of specific objects assigned to the cluster is determined, each of the specific objects having a singular affinity not less than said phase-specific affinity threshold.

During each cycle, for each cluster, a cycle-specific vector sum of object vectors of all objects assigned to said each cluster is determined.

The process of updating a centroid vector of a cluster comprises equating the centroid vector to a summation of the phase-specific vector sum and the cycle-specific vector sum divided by a total number of objects assigned to the cluster upon completion of said each cycle.

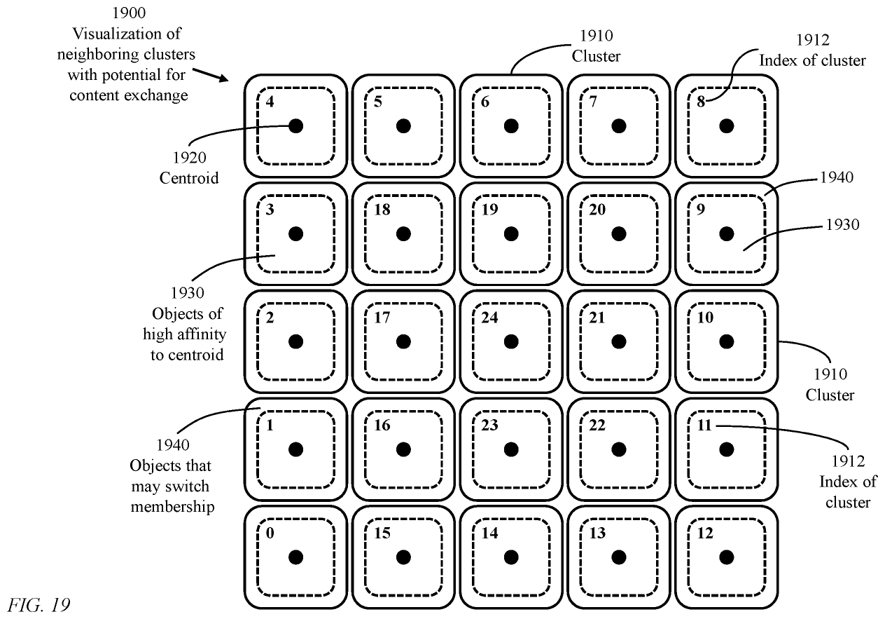

FIG. 19 illustrates a representation 1900 of 25 clusters 1910 of a population of objects at a stage of cluster formation. The clusters are represented as regular shapes for ease of illustration. Naturally, clusters would have different boundaries in a multidimensional representation. The clusters are indexed sequentially as 0 to 24. The indices 1912 and centroids 1920 of the clusters are indicated. The objects of each cluster are divided into a set 1930 of locked objects and a set of free objects 1940. As described above with reference to FIGS. 16, 17, and 18, reallocation of objects to clusters is performed only for free objects to reduce redundant computations. In accordance with an embodiment of the present invention, further computational efficiency may be realized when the inter-cluster affinity levels are taken into consideration. During early cycles 1110 or 1210 of centroid update, all objects are treated as free objects and the search domain covers all of the clusters, i.e., each cluster is a candidate for each object. However, during subsequent phases, a proportion of objects within a cluster may be locked to the cluster while remaining free objects may look for potentially better clusters.

Whether or not the feature of locking objects to clusters is activated, the computational effort may be reduced by limiting the search domain. During a cycle of centroid update, an object of a specific cluster may consider migrating to a cluster of high affinity to the specific cluster. The inter-cluster affinity may be determined in terms of respective inter-centroid affinity. After completion of a centroid-update cycle, the affinity of each pair of centroids may be determined. With K centroids, the number of computations of inter-cluster affinity levels is (K×(K−1))/2 which significantly smaller than the number of computations N×K of object-cluster affinity levels since N is typically much larger than K. With 1000,000 objects (N=1000000) and 100 clusters (K=100), for example, the number of computations of an affinity level of each object to each centroid would be 10⁸, while the number of computations of inter-cluster affinity levels would be 4950. Additionally, a centroid pair of low affinity, below a predefined lower bound, may be eliminated.

The compound effect of activating the feature of locking objects to clusters and limiting the search domain can be a significant reduction of the overall computational effort.

Table-I identifies neighboring clusters of each of the 25 clusters of FIG. 19. A neighbor of a specific cluster is a cluster having an affinity level to the specific cluster exceeding a predefined affinity lower bound. The neighbors of cluster 1910 of index 5, for example, are the clusters 1910 of indices 3, 4, 6, 19, and 18. An object belonging to the cluster of index 5 may consider migrating to any of the listed neighbors. The rationale behind this limitation is the high likelihood of the affinity level of the object to any of the other 19 clusters being significantly smaller than the affinity level of the object to the current cluster (of index 5).

TABLE I
Neighboring clusters

| | |
|---|---|
| Index of | |
| reference | |
| cluster | Indices of neighboring clusters |

| | | | | | | | | |
|---|---|---|---|---|---|---|---|---|
| 0 | 1 | 15 | 16 | | | | | |
| 1 | 0 | 2 | 15 | 16 | 17 | | | |
| 2 | 1 | 3 | 16 | 17 | 18 | | | |
| 3 | 2 | 4 | 5 | 18 | 17 | | | |
| 4 | 3 | 5 | 18 | | | | | |
| 5 | 4 | 6 | 3 | 18 | 19 | | | |
| 6 | 5 | 7 | 18 | 19 | 20 | | | |
| 7 | 6 | 8 | 9 | 19 | 20 | | | |
| 8 | 7 | 9 | 20 | | | | | |
| 9 | 8 | 10 | 7 | 20 | 21 | | | |
| 10 | 9 | 11 | 20 | 21 | 22 | | | |
| 11 | 10 | 12 | 13 | 21 | 22 | | | |
| 12 | 11 | 13 | 22 | | | | | |
| 13 | 12 | 14 | 11 | 22 | 23 | | | |
| 14 | 13 | 15 | 16 | 22 | 23 | | | |
| 15 | 0 | 14 | 1 | 16 | 23 | | | |
| 16 | 1 | 23 | 15 | 17 | 0 | 2 | 24 | 14 |
| 17 | 2 | 24 | 16 | 18 | 1 | 3 | 19 | 23 |
| 18 | 3 | 19 | 5 | 17 | 2 | 4 | 6 | 24 |
| 19 | 18 | 20 | 6 | 24 | 5 | 7 | 17 | 21 |
| 20 | 19 | 9 | 7 | 21 | 6 | 8 | 10 | 24 |
| 21 | 24 | 10 | 20 | 22 | 11 | 23 | 19 | 9 |
| 22 | 23 | 11 | 13 | 21 | 12 | 14 | 24 | 10 |
| 23 | 16 | 22 | 14 | 24 | 13 | 15 | 17 | 21 |
| 24 | 17 | 21 | 23 | 19 | 22 | 16 | 18 | 20 |

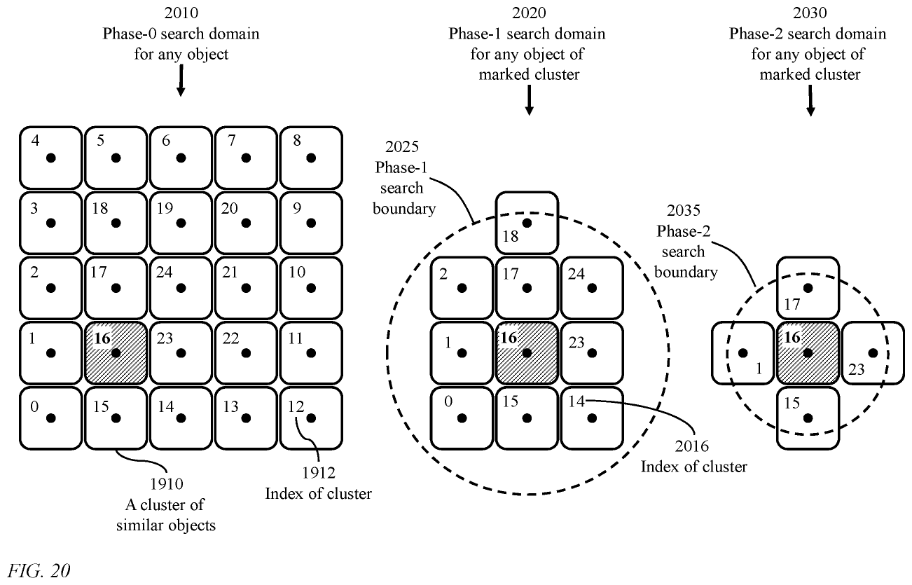

FIG. 20 illustrates updating search domain for a selected cluster (cluster 1910 of index 16) during successive centroid-update phases. During an initial phase 2010 (phase-0) covering a respective number of centroid-update cycles 1110 or 1210, the search domain for objects of any cluster covers all clusters. During a subsequent phase 2020 (phase-1), the search domain is limited to be within a search boundary 2025 corresponding to a predefined phase-1 affinity lower bound (0.25, for example). During a following phase 2030 (phase-2), the search domain is limited to be within a search boundary 2035 corresponding to a predefined phase-2 affinity lower bound (0.4, for example). The affinity lower bound defining a search boundary 2025, 2035, etc., increases gradually, hence the search boundary tightens, as further centroid-update phases are actuated.

Thus, the invention provides a method of clustering a plurality of objects comprising: determining for each object of the plurality of objects a respective characterizing object vector;
initializing a set of clusters of objects as empty sets;
assigning a centroid with a respective centroid vector to every cluster of the set of clusters;
during each phase of successive phases, determining for each cluster a respective phase-specific search domain applicable to constituent objects of each cluster and actuating a predefined number of cycles performing for each cycle processes of:
   determining an affinity level of each object to each neighboring cluster within a corresponding phase-specific search domain according to the respective characterizing object vector and a centroid vector of said each neighboring cluster; and
   assigning said each object to a specific cluster corresponding to highest affinity level.

Upon completion of each cycle, updating a centroid vector of said each cluster.

The method further comprises setting the respective phase-specific search domain to be the set of clusters for an initial phase of said successive phases. Upon completion of each phase, performing steps of
determining an affinity level of each cluster to each other cluster within said set of clusters;
identifying for each cluster neighboring clusters constituting the respective phase-specific search domain, each neighboring cluster having an affinity level exceeding a phase-specific affinity lower bound.

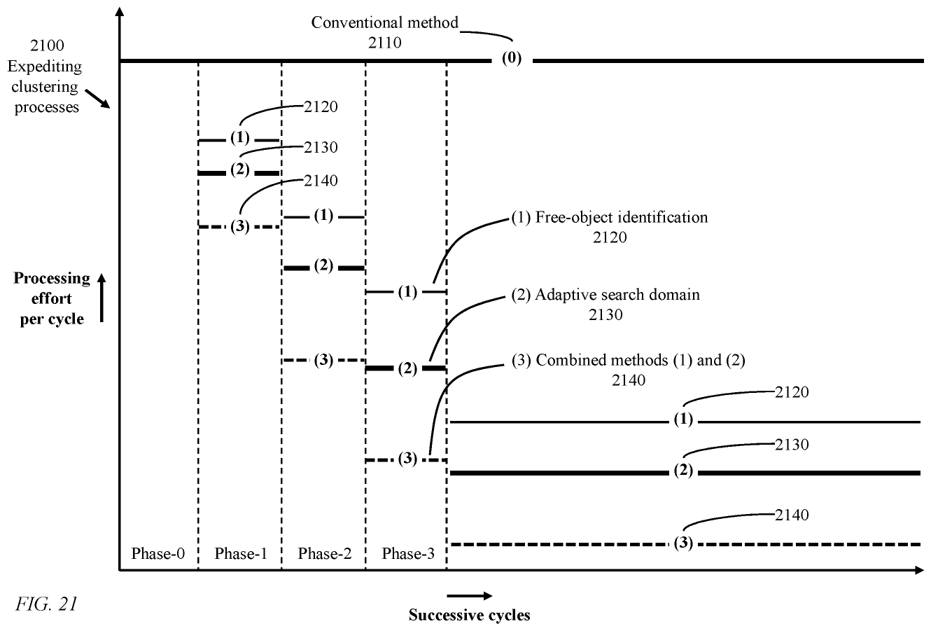

FIG. 21 illustrates processing effort during successive centroid-update phases for different clustering methods. Generally, the assignment of objects of a population of objects to a set of clusters is realized with iterative executions of a global cycle where α cluster-selection procedure is executed to select a cluster for an object, assign the object to the selected cluster, and then update the centroid of the selected cluster. Conventionally, during a global cycle, an affinity level of each object of the entire population of objects to each cluster of the set of clusters is computed during each of successive global cycles. An affinity level of an object to a centroid of a cluster represents the affinity level to the cluster. Thus, the processing effort per cycle is virtually the same for each cycle as illustrated in FIG. 21 (reference 2110). With N objects and K clusters, the number of executions of an affinity computation process is N×K; typically, N>>K.

According to the first method of expediting clustering processes, described above with reference to FIG. 17 and FIG. 18, during successive cycles, the content of a cluster may be divided into a set of locked objects and a set of free objects with the proportion of free objects gradually decreasing as the number of actuated cycles increases. The free objects may be reallocated to different clusters during subsequent centroid-update cycles. A locked object has a fidelity value, with respect to the centroid of the cluster, exceeding a “global affinity threshold”. The global affinity threshold starts at the maximum value (of 1.0) and is decreased gradually resulting in a gradual decrease of the proportion of free objects.

Thus, as illustrated in FIG. 21 (label (1), reference 2120), the processing effort per cycle decreases gradually. Each of phase-0, phase-1, phase-2, and phase-3 covers a number of cycles; for examples, five cycles each. In the example of FIG. 21, the global affinity threshold is kept unchanged, and hence the processing effort per cycle remains virtually unchanged, after phase-3.

According to the second method of expediting clustering processes, described above with reference to FIG. 19 and FIG. 20, the search domain for each object is gradually tightened as the number of cycles increases. During an initial phase (phase-0), the search domain is the entire set of created clusters. During subsequent phases (phase-1, phase-2, etc.) the search domain for members of a cluster is determined according to naturally changing inter-cluster affinity levels and an “affinity lower bound” which is increased gradually as the number of centroid-update cycles increases.

Thus, as illustrated in FIG. 21 (label (2), reference 2130), the processing effort per cycle decreases gradually. In the example of FIG. 21, the affinity lower bound is kept unchanged, and hence the processing effort per cycle remains virtually unchanged, after phase-3.

The first and second methods of expediting clustering processes may be combined resulting in further decrement of the requisite processing effort as illustrated in FIG. 21 (label (3), reference 2140).

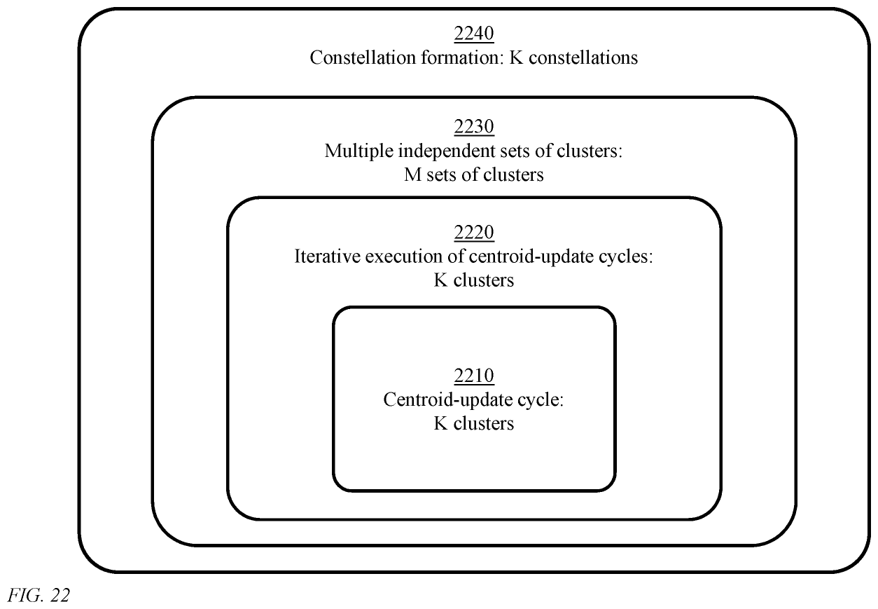

FIG. 22 illustrates formation of constellations of clusters based on generation of a plurality of independent sets of clusters. Process 2210 performs a global centroid update cycle (1110 or 1210) starting with a set of centroids (initially a set of centroid seeds) for a specified order of assigning objects to clusters. Process 2220, herein referenced as a “segmentation process” activates process 2210 iteratively with the set of centroids automatically updated during each activation of process 2210. The order of selecting objects may change from one cycle to another but the set of centroids is self adjusting. Process 2230 activates process 2220 (with corresponding multiple activation of process 2210) M times, M>1, using M different sets of centroid seeds and different sets of pseudo-random indices corresponding to addresses of object descriptor vectors stored in a memory device (storage medium in general). Each of the M activations of process 2220 produces a set of centroids of clusters. Naturally, the clusters resulting from any activation of process 2220 overlap clusters resulting from any other activation of process 2220. Two clusters are said to be overlapping if they contain at least one common object. Process 2240 forms constellations.

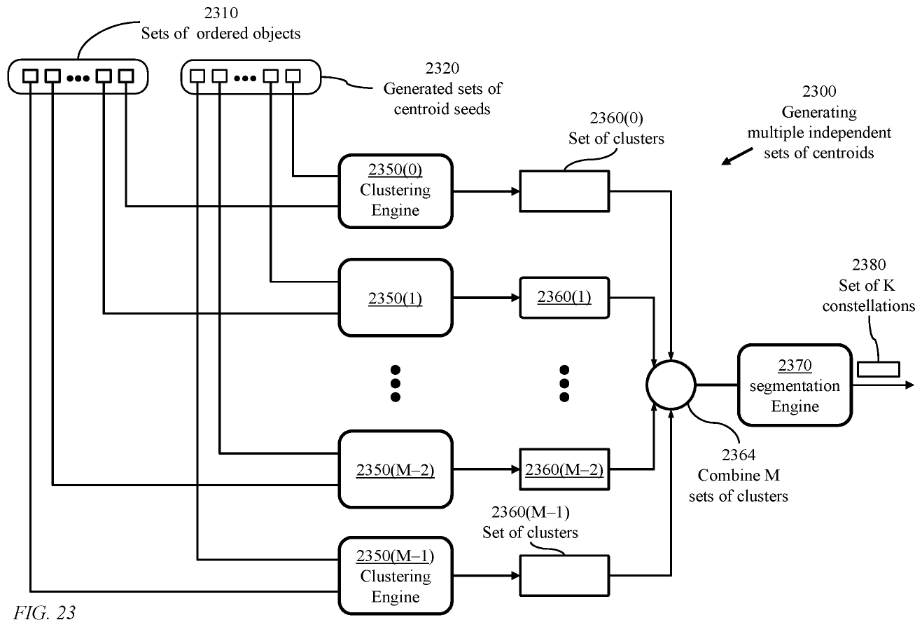

FIG. 23 illustrates a mechanism 2300 for generating constellations of clusters. A bank of M clustering engines individually identified as 2350(0) to 2350(M−1), M>1, each engine implementing process 2220. The engines may be activated concurrently. The mechanism receives multiple sets 2310 of pseudo-random addresses of N object descriptor vectors and M different sets 2320 of centroid seeds which are supplied to the bank of engines. Each engine 2350 comprises a hardware processor and a storage medium holding software instructions causing the hardware processor to perform process 2220 starting with a respective set 2320 of centroid seeds and an order of allocating the N objects. Each engine 2350 generates a set of clusters held in a respective memory device 1860. The generated M sets of clusters are combined (reference 2364) and presented to segmentation engine 2370 to produce a set of constellations.

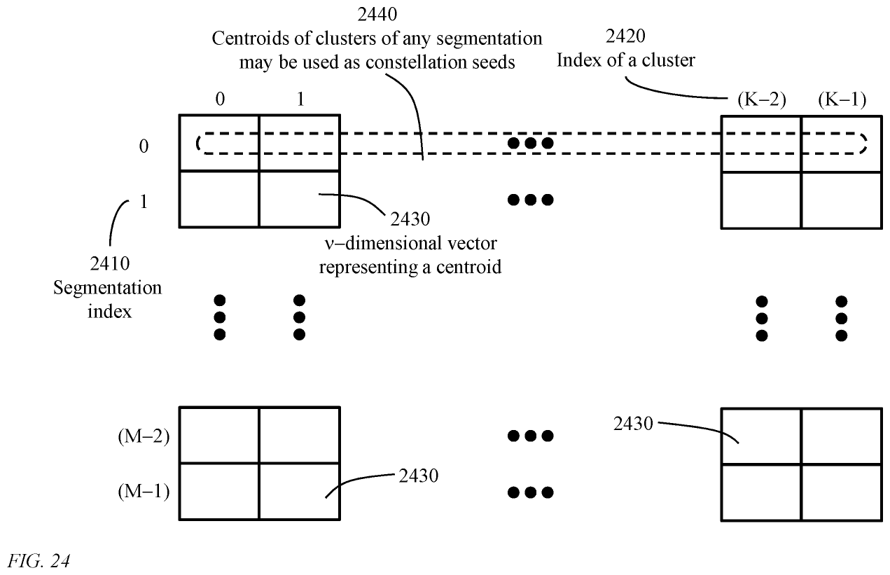

FIG. 24 illustrates a set of M centroid sets corresponding to M independently generated sets of clusters. The M centroid sets are indexed sequentially (reference 2410) as 0 to (M−1). Each centroid set is produced by a segmentation process 2220 and comprises K centroid vectors 2430 indexed sequentially (reference 2420) as 0 to (K−1). A centroid vector 2430 comprises ν centroid descriptors, ν>0. A selected set 2440 of centroids is designated as a set of constellation seeds. Any of the M centroid sets may be used as a set of constellation seeds.

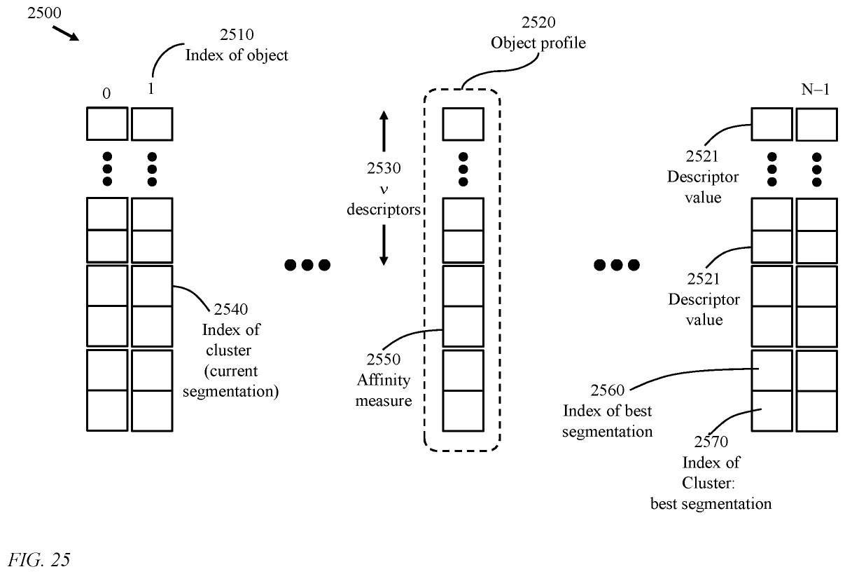

FIG. 25 illustrates an array 2500 of object profiles 2520 of N objects. The objects are indexed sequentially (reference 2510) as 0 to (N−1). Each object profile 2520 comprises ν entries 2530 containing (static) descriptor values 2521 of the object and four entries tracking potentially changing assignment of the object to a centroid. An entry 2540 holds an index of an assigned cluster for the object during a current cycle. An entry 2550 indicates an affinity level of the object to the currently assigned cluster. An index 2560 contains an index of a segmentation (one of 0 to (M−1) corresponding to the highest object-cluster fidelity level. An entry 2570 contains an index of the cluster (one of 0 to (K−1)) within the segmentation indicated in entry 2560.

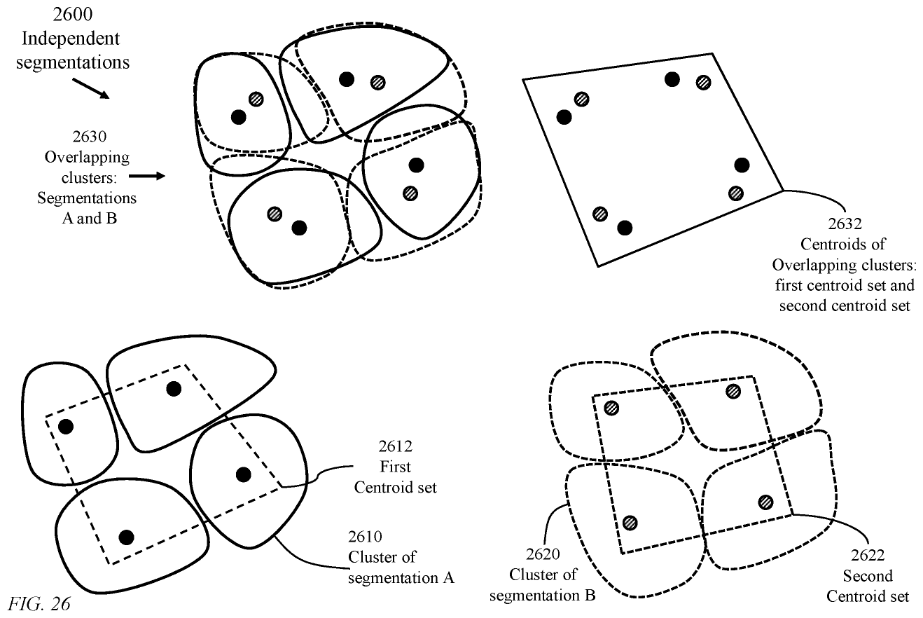

FIG. 26 illustrates two independent sets of clusters corresponding two segmentations 2600 labeled segmentation-A and segmentation-B. In the illustrated example, segmentation-A produces four clusters 2610 with a first set 2612 of centroids and segmentation-B produces four clusters 2620 with a second set of centroids 2622. The set of clusters 2630 comprises combined overlapping clusters 2610 and 2620. Centroid set 2632 comprises the first set 2612 of centroids and the second set 2622 of centroids. Process 2230 actuates M segmentations producing M×K centroids. A centroid-grouping process similar to the clustering process of FIG. 11 or FIG. 12 may be applied, with the M×K centroids replacing the N objects, to produce K constellations of centroids.

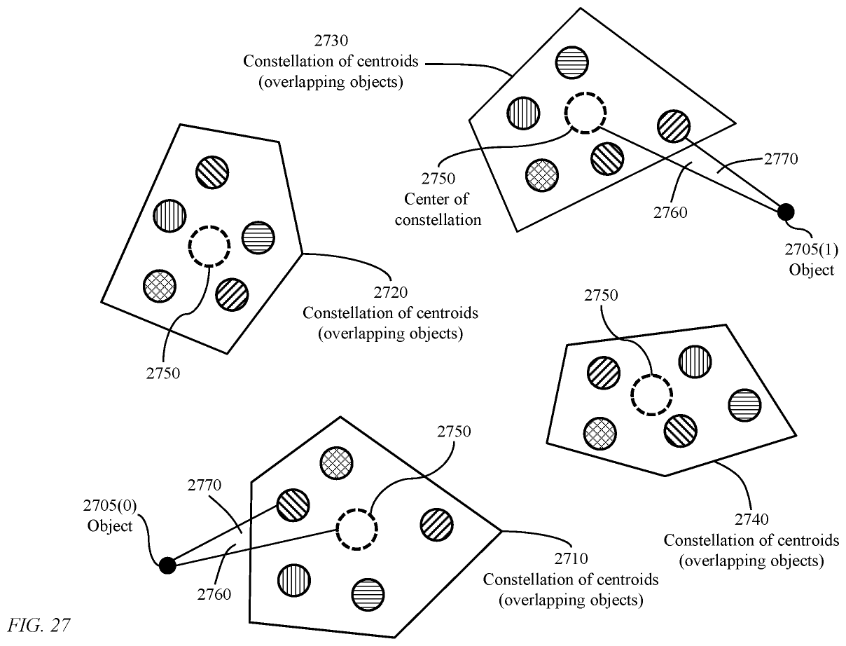

FIG. 27 illustrates forming constellations 2710, 2720, 2730, and 2740 of centroids for a case where the number, M, of segmentations is only five. A center 2750 of a constellation is determined as the sum of centroid vectors of the centroids of the constellation divided by M. With a set of constellation centers 2750 determined, the affinity level of each of the N objects to each constellation is determined. Each object 2705 is then assigned to the constellation of highest affinity level (reference 2760). The affinity level of an object to a constellation is defined as the affinity level of the object to the centroid of the constellation.

Alternatively, instead of object-constellation assignment based on determining the affinity level of each of the N objects to each of the constellation centers, object-constellation assignment may be based on the already tracked information of FIG. 25. The profile 2520 of an object includes an index 2560 of the best segmentation for the object and an index 2570 of the specific cluster of the best segmentation to which the object belongs. Thus, the object joins the constellation containing the specific cluster without performing a search process (reference 2770).

Thus, the invention provides a method of segmenting a plurality of objects based on performing multiple independent segmentation processes where each segmentation process produces a set of object clusters. The method comprises steps of storing descriptor vectors of N objects of the plurality of objects in a memory device, and configuring at least one hardware processor to perform processes of generating a plurality of distinct sets of K centroid seeds, 3<2K<N, generating a plurality of distinct pseudo-random sequences of N non-repeating integers corresponding to memory addresses of descriptor vectors, and executing M independent segmentation processes of the N objects, M>2.

Each segmentation process is based on composite radial-angular affinity. A segmentation process starts with a respective one of the sets of K centroid seeds then selects objects for allocation to clusters according to a respective pseudo-random sequence. Each segmentation produces a respective set of K centroids.

Executing the M segmentation processes produces a plurality of centroids which are, in turn segmented into K constellations starting with any of the sets of K centroids as K constellation seeds and assigning each of remaining centroids to one of K constellations. Upon formation of the constellations, each object selected according to a respective pseudo-random sequence is allocated to a respective constellation according to constituent centroids of the constellations.

The M independent segmentation processes may be executed sequentially or concurrently.

Each segmentation comprises assigning each centroid seed to a respective cluster of a set of K clusters and for each object selected according to a respective pseudo-random sequence performing processes of evaluating a composite affinity measure to each centroid of the K centroids identifying a particular centroid of highest composite affinity measure; and assigning each selected object to a particular cluster corresponding to the particular centroid. The composite affinity measure is based on a radial-affinity measure and an angular-affinity measure to each centroid. The particular centroid is then updated to account for inclusion of each selected object.

According to an implementation, allocating an object to a respective constellation comprises steps of determining a center of each constellation of the K constellations, based on the constituent centroids of the constellations, and determining an affinity measure of the object to the center. The object is assigned to a constellation to the center of which the object has highest affinity measure

According to another implementation, allocating an object to a respective constellation comprises steps of identifying a specific centroid of the plurality of centroids to which the object has highest composite affinity measure and selecting a constellation containing the specific centroid.

The method further comprises maintaining object-assignment records indicating for each selected object an identifier of a cluster to which each selected object is assigned and a corresponding composite affinity measure.

Systems and apparatus of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the techniques of this disclosure.

It should be noted that methods and systems of the embodiments of the invention and data sets described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of clustering a plurality of objects comprising:
configuring at least one hardware processor to perform processes of:
generating a set of K centroids, K>1;
assigning each centroid to a respective cluster of a set of K clusters;
selecting objects of said plurality of objects in a predetermined order and for each object of said plurality of objects:
evaluating a composite affinity measure to each centroid of the K centroids based on a radial-affinity measure and an angular-affinity measure to said each centroid;
identifying a particular centroid of highest composite affinity measure;
assigning said each object to a particular cluster corresponding to the particular centroid; and
updating said particular centroid to a respective updated centroid to account for inclusion of said each object;
and
storing identifiers of objects assigned to said each cluster.

2. The method of claim 1 wherein said each object is characterized by a respective vector of descriptors and said updating comprises steps of:
maintaining a count of current objects assigned to said particular cluster;
maintaining a vector sum of vectors of descriptors of said current objects; and
determining said respective updated centroid as said vector sum divided by said count.

3. The method of claim 1 further comprising:
assigning to said each object a respective weight; and
establishing said predetermined order as a descending order according to weight.

4. The method of claim 1 further comprising executing multiple cycles of said selecting, evaluating, identifying, assigning, and updating for said each object with the predetermined order for any cycle differing from the predetermined order for any other cycle of the multiple cycles.

5. The method of claim 4 further comprising, for each cycle of said multiple cycles:
generating a respective pseudo-random sequence of different integers corresponding to memory addresses of vectors of descriptors of said plurality of objects; and
establishing said predetermined order according to said respective pseudo-random sequence.

6. The method of claim 1 further comprising:
maintaining object-assignment records indicating for each object:
an identifier of a cluster to which said each object is assigned; and
a corresponding composite affinity measure;
executing a specified number of cycles of said selecting, evaluating, identifying, assigning, and updating for said each object of said plurality of objects; and
executing each of a specified number of succeeding cycles of said selecting, evaluating, identifying, assigning, and updating for only each object of a composite affinity measure below a specified level.

7. The method of claim 1 further comprising:
determining an overall number of changes of object assignments to clusters for a cycle of said selecting, said evaluating, identifying, assigning, and updating for said each object; and
while a ratio of said overall number to a total number of objects of said plurality of objects exceeds a predefined threshold repeating said cycle at most a predefined number of times.

8. The method of claim 1 further comprising determining each of said radial-affinity measure, said angular-affinity measure, and said composite affinity measure as a normalized value bounded between 0 and 1.0.

9. The method of claim 1 wherein:
said angular affinity measure is determined as a dot product of vectors (C/∥C∥) and (P/∥P∥);
said radial affinity measure is determined as a ratio ∥P∥/(∥P∥+D); and
said composite affinity measure is a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥.

10. The method of claim 1 wherein:
said angular affinity measure is determined as a dot product of vectors (C/∥C∥) and (P/∥P∥);
said radial affinity measure is determined as (1−D/D*) for D<D* and 0.0 otherwise; and
said composite affinity measure is a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥, and D* is a predefined distance threshold, D*>0.

11. A system of clustering a plurality of objects comprising:
at least one hardware processor and at least one memory device storing processor readable instructions causing the at least one hardware processor to:
generate a set of K centroids, K>1;
assign each centroid to a respective cluster of a set of K clusters;
select objects of said plurality of objects in a predetermined order and for each object of said plurality of objects:
evaluate a composite affinity measure to each centroid of the K centroids based on a radial-affinity measure and an angular-affinity measure to said each centroid;
identify a particular centroid of highest composite affinity measure;
assign said each object to a particular cluster corresponding to the particular centroid; and
update said particular centroid to a respective updated centroid to account for inclusion of said each object;
and
store identifiers of objects assigned to said each cluster.

12. The system of claim 11 further comprising means for characterizing said each object by a respective vector of descriptors, said processor readable instructions further causing said at least one hardware processor to:
maintain a count of current objects assigned to said particular cluster;
maintain a vector sum of vectors of descriptors of said current objects; and
determine said respective updated centroid as said vector sum divided by said count.

13. The system of claim 11 further comprising means for assigning to said each object a respective weight, said processor readable instructions further causing said at least one processor to establish said predetermined order as a descending order according to weight.

14. The system of claim 11 wherein said processor readable instructions further cause said at least one hardware processor to execute multiple cycles of assigning said plurality of objects to said set of clusters with the predetermined order of selecting objects for any cycle differing from the predetermined order for any other cycle of the multiple cycles.

15. The system of claim 14 wherein said processor readable instructions further cause said at least one hardware processor to:
generate, for each cycle of said multiple cycles, a respective pseudo-random sequence of different integers corresponding to memory addresses of vectors of descriptors of said plurality of objects; and
establish said predetermined order according to said respective pseudo-random sequence.

16. The system of claim 11 wherein said processor readable instructions further cause said at least one processor to:
maintain object-assignment records indicating for each object:
an identifier of a cluster to which said each object is assigned; and
a corresponding composite affinity measure;
execute a specified number of cycles of assigning objects to clusters for said each object of said plurality of objects; and
execute each of a specified number of succeeding cycles of assigning objects to clusters for only each object of a composite affinity measure below a specified level.

17. The system of claim 11 wherein said processor readable instructions further cause said at least one hardware processor to:
determine an overall number of changes of object assignments to clusters for a cycle of assigning objects to clusters for said each object; and
repeat said cycle at most a predefined number of times while a ratio of said overall number to a total number of objects of said plurality of objects exceeds a predefined threshold.

18. The system of claim 11 further comprising causing the at least one hardware processor to determine each of said radial-affinity measure, said angular-affinity measure, and said composite affinity measure as a normalized value bounded between 0 and 1.0.

19. The system of claim 11 wherein said processor readable instructions further cause said at least one hardware processor to:
determine said angular affinity measure as a dot product of vectors (C/∥C∥) and (P/∥P∥);
determine said radial affinity measure as a ratio ∥P∥/(∥P∥+D); and
determine said composite affinity measure as a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥.

20. The system of claim 11 wherein said executable instructions further cause said at least one hardware processor to:
determine said angular affinity measure as a dot product of vectors (C/∥C∥) and (P/∥P∥);
determine said radial affinity measure as (1−D/D*) for D<D* and zero otherwise; and
determine said composite affinity measure as a weighted sum of said angular affinity measure and said radial affinity measure;
where C denotes a centroid vector of said each centroid, P denotes an object vector of said each object vector, ∥C∥ denotes magnitude of C, ∥P∥ denotes magnitude of P, and D denotes the Euclidean distance ∥(P−C)∥, and D* is a predefined distance threshold, D*>0.
